(19) United States
(12) Patent Application Publication
(10) Pub. No.: US 2015/0024199 A1
(43) Pub. Date: Jan. 22, 2015

(54) REMOVABLE WATER-DISPERSIBLE PRESSURE-SENSITIVE ADHESIVE COMPOSITION, PRESSURE-SENSITIVE ADHESIVE SHEET AND OPTICAL COMPONENT

(71) Applicant: NITTO DENKO CORPORATION, Ibaraki-shi (JP)

(72) Inventors: Yu Morimoto, Ibaraki-shi (JP); Kazuma Mitsui, Ibaraki-shi (JP); Tatsumi Amano, Ibaraki-shi (JP)

(21) Appl. No.: 14/330,471

(22) Filed: Jul. 14, 2014

(30) Foreign Application Priority Data
Jul. 17, 2013 (JP) 2013-148839

(51) Int. Cl. C09J 7/02; G02B 1/04; C09J 133/08

(52) U.S. Cl. CPC C09J 7/0217; C09J 133/08; G02B 1/04; C09J 2433/00; C09J 2467/006
USPC 428/355 R; 524/265

(57) ABSTRACT

There is provided a removable water-dispersible pressure-sensitive adhesive composition to form a pressure-sensitive adhesive layer of a pressure-sensitive adhesive sheet capable of exhibiting good curl regulatability. There are also provided a pressure-sensitive adhesive sheet capable of exhibiting good curl regulatability, and an optical component having the pressure-sensitive adhesive sheet laminated thereon. The removable water-dispersible pressure-sensitive adhesive composition according to the present invention forms a pressure-sensitive adhesive layer of a pressure-sensitive adhesive sheet having an initial curl height of not less than 20 mm as determined by a curl test, and a difference in curl height of not more than 10 mm as determined by the curl test. The pressure-sensitive adhesive sheet according to the present invention has a pressure-sensitive adhesive layer formed of the removable water-dispersible pressure-sensitive adhesive composition. The optical component according to the present invention has the pressure-sensitive adhesive sheet laminated thereon.

### TECHNICAL FIELD

The present invention relates to a water-dispersible pressure-sensitive adhesive composition capable of forming a removable pressure-sensitive adhesive layer. The present invention also relates to a pressure-sensitive adhesive sheet having a pressure-sensitive adhesive layer formed of the pressure-sensitive adhesive composition, and an optical component having the pressure-sensitive adhesive sheet laminated thereon.

### BACKGROUND ART

In the manufacture and processing steps of optical components (optical materials) including optical films such as polarizing plates, retardation plates and antireflection plates, for the purpose of the prevention of flaws and stains of the surface, improvement in cutting processability, the suppression of cracking and the like, surface protection films are laminated and used on the surfaces of the optical components. As these surface protection films, removable pressure-sensitive adhesive sheets are used in which a removable pressure-sensitive adhesive layer is provided on the surface of a plastic film base material (see Patent Literatures 1 and 2).

### CITATION LIST

### Patent Literature

Patent Literature 1: Japanese Patent Laid-Open No. 2008-69261
Patent Literature 2: Japanese Patent Laid-Open No. 11-116927

### SUMMARY OF INVENTION

### Technical Problem

It has recently been much demanded on surface protection films that when the surface protection films are laminated on optical components, unnecessary curl and unintended curl (curl refers to a warping phenomenon, for example, a phenomenon that a platy material is wholly warped to either one surface side and a phenomenon that a platy material is wholly undulatedly warped) are not generated on the optical components. This is because many optical components easily generating curl have been used, and the generation of unnecessary curl and unintended curl causes defects in processes of fabricating products (for example, liquid crystal panels) using optical components.

Therefore, when a pressure-sensitive adhesive sheet is used as a surface protection film, the pressure-sensitive adhesive sheet capable of being regulated in the generation of unnecessary curl and unintended curl on optical components having the surface protection film laminated thereon is demanded, and a pressure-sensitive adhesive composition to form a pressure-sensitive adhesive layer which the pressure-sensitive adhesive sheet has is demanded.

Therefore, it is an object of the present invention to provide a removable water-dispersible pressure-sensitive adhesive composition to form a pressure-sensitive adhesive layer of a pressure-sensitive adhesive sheet capable of exhibiting good curl regulatability.

It is also another object of the present invention to provide a pressure-sensitive adhesive sheet capable of exhibiting good curl regulatability, and an optical component having the pressure-sensitive adhesive sheet laminated thereon.

### Solution to Problem

Then, as a result of exhaustive studies to solve the above-mentioned problem, the present inventors have found that if an initial curl height determined in a predetermined curl test is not less than a specific value and the difference between curl heights determined in a predetermined curl test is not more than a specific value, a pressure-sensitive adhesive layer of a pressure-sensitive adhesive sheet capable of exhibiting good curl regulatability can be formed, and this finding has led to the completion of the present invention.

It has further been found that if a water-dispersible pressure-sensitive adhesive composition is made to be a composition having a specific composition, which contains an acryl emulsion-based polymer constituted of specific raw material monomers, a water-insoluble crosslinking agent, and an ether group-containing polysiloxane or a polyether-type defoaming agent, a pressure-sensitive adhesive layer of a pressure-sensitive adhesive sheet capable of exhibiting good curl regulatability can be formed, and this finding has led to the completion of the present invention.

That is, the present invention provides a removable water-dispersible pressure-sensitive adhesive composition to form a pressure-sensitive adhesive layer of a pressure-sensitive adhesive sheet in which the initial curl height determined in the following curl test is not less than 20 mm, and the difference between curl heights determined in the following curl test is not more than 10 mm.

### (Curl Test)

A pressure-sensitive adhesive layer of 20 μm in thickness formed of the removable water-dispersible pressure-sensitive adhesive composition is formed on one surface of a polyethylene terephthalate base material of 38 μm in thickness to thereby obtain a pressure-sensitive adhesive sheet for the test having the pressure-sensitive adhesive layer on the one surface of the polyethylene terephthalate base material.

The pressure-sensitive adhesive sheet for the test is laminated on a triacetyl cellulose-made polarizing plate (trade name: “SEG1425DU”, made by Nitto Denko Corp., 140 mm in width, 200 mm in length, 0.3 mm in thickness) by using a laminator under conditions of 0.26 MPa and 0.3 m/min so that the length direction of the polarizing plate and the length direction of the pressure-sensitive adhesive sheet for the test are coincident, to thereby obtain a sample for curl test evaluation.

The sample for curl test evaluation is placed on a flat surface, and respective distances (distances in the height direction) from the flat surface to four corners of the sample are measured. Then, an average of these values is determined, and the average is taken as an “initial curl height”.

After the determination of the “initial curl height”, the sample for evaluation is left under the environment of 23° C. and 50% RH for 20 hours. After being left, the sample for evaluation is placed on a flat surface, and respective distances (distances in the height direction) from the flat surface to four corners of the sample are measured. Then, an average of these values is determined, and the average is taken as a “curl height after 20 hours”.

Then, a “difference in curl height” is determined from the difference between the “initial curl height” and the “curl height after 20 hours”.

The present invention also provides a removable water-dispersible pressure-sensitive adhesive composition containing an acryl emulsion-based polymer, a water-insoluble crosslinking agent, an acetylenediol-based compound, and an other group-containing polysiloxane or a polyether-type defoaming agent,

wherein the acryl emulsion-based polymer is constituted of an alkyl(meth)acrylate and a carboxyl group-containing unsaturated monomer as essential raw material monomers, wherein the content of the alkyl(meth)acrylate is 70 to 99.5% by weight with respect to the total amount of the raw material monomers, and the content of the carboxyl group-containing unsaturated monomer is 0.5 to 10.0% by weight with respect to the total amount of the raw material monomers; and

wherein a value (A) determined by the following expression (1) is 0.2 to 0.7, or a value (B) determined by the following expression (2) is 0.2 to 2.0.

Value(A)=(X)×(Y) (1)

Value(B)=(X)×(Z) (2)

X: a content of the water-insoluble crosslinking agent, which is expressed in an amount thereof (parts by weight) with respect to 100 parts by weight of the acryl emulsion-based polymer.

Y: a content of the ether group-containing polysiloxane, which is expressed in an amount thereof (parts by weight) with respect to 100 parts by weight of the acryl emulsion-based polymer.

Z: a content of the polyether-type defoaming agent, which is expressed in an amount thereof (parts by weight) with respect to 100 parts by weight of the acryl emulsion-based polymer.

The present invention further provides a pressure-sensitive adhesive sheet having a pressure-sensitive adhesive layer formed of the removable water-dispersible pressure-sensitive adhesive composition.

The present invention further provides an optical component having the pressure-sensitive adhesive sheet laminated thereon.

### Advantageous Effects of Invention

The removable water-dispersible pressure-sensitive adhesive composition according to the present invention can form a pressure-sensitive adhesive layer of a pressure-sensitive adhesive sheet capable of exhibiting good curl regulatability.

The pressure-sensitive adhesive sheet according to the present invention, since having a pressure-sensitive adhesive layer formed of the removable water-dispersible pressure-sensitive adhesive composition, can exhibit good curl regulatability.

### BRIEF DESCRIPTION OF DRAWING

FIG. 1 is a schematic side elevation of a sample for curl test evaluation when the curl height is measured in a curl test.

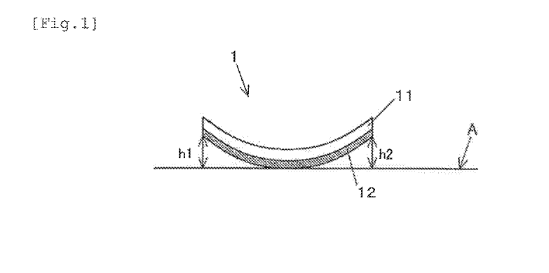

### DESCRIPTION OF EMBODIMENTS

### [Removable Water-Dispersible Pressure-Sensitive Adhesive Composition]

The removable water-dispersible pressure-sensitive adhesive composition according to the present invention is a composition to form a pressure-sensitive adhesive layer which a pressure-sensitive adhesive sheet has, and is a “water-dispersible” pressure-sensitive adhesive composition. Here, the “water-dispersible” refers to being capable of being dispersed in an aqueous medium. That is, the removable water-dispersible pressure-sensitive adhesive composition according to the present invention is a pressure-sensitive adhesive composition capable of being dispersed in an aqueous medium. The aqueous medium is a medium (disperse medium) containing water as an essential component, and may be water singly, or a mixture of water with a water-soluble organic solvent. The removable water-dispersible pressure-sensitive adhesive composition according to the present invention may be a dispersion liquid using the aqueous medium. In the present description, the removable water-dispersible pressure-sensitive adhesive composition according to the present invention is simply referred to as a “pressure-sensitive adhesive composition according to the present invention” in some cases.

A pressure-sensitive adhesive sheet having a pressure-sensitive adhesive layer formed of the pressure-sensitive adhesive composition according to the present invention has the removability; and when the pressure-sensitive adhesive sheet is peeled off after being laminated on an adherend, the pressure-sensitive adhesive sheet can be peeled off without causing break of the pressure-sensitive adhesive sheet and break of the adherend and without leaving the pressure-sensitive adhesive remaining on the adherend surface. In the present description, a “pressure-sensitive adhesive tape or sheet” is simply referred to as a “pressure-sensitive adhesive tape” or a “pressure-sensitive adhesive sheet” in some cases.

The pressure-sensitive adhesive composition according to the present invention preferably forms a pressure-sensitive adhesive layer of a pressure-sensitive adhesive sheet in which the initial curl height determined in the following curl test is not less than 20 mm, and the difference between curl heights determined in the following curl test is not more than 10 mm. If the pressure-sensitive adhesive composition according to the present invention can form a pressure-sensitive adhesive layer of a pressure-sensitive adhesive sheet having such a property, the pressure-sensitive adhesive layer of the pressure-sensitive adhesive sheet capable of exhibiting good curl regulatability can be formed.

### (Curl Test)

A pressure-sensitive adhesive layer of 20 μm in thickness formed of the pressure-sensitive adhesive composition according to the present invention is formed on one surface of a polyethylene terephthalate base material of 38 μm in thickness to thereby obtain a pressure-sensitive adhesive sheet for the test having the pressure-sensitive adhesive layer on the one surface of the polyethylene terephthalate base material.

The pressure-sensitive adhesive sheet for the test is laminated on a triacetyl cellulose-made polarizing plate (trade name: “SEG1425DU”, made by Nitto Denko Corp., 140 mm in width, 200 mm in length, 0.3 mm in thickness) by using a laminator under conditions of 0.26 MPa and 0.3 m/min so that the length direction of the polarizing plate and the length direction of the pressure-sensitive adhesive sheet for the test are coincident, to thereby obtain a sample for curl test evaluation.

The sample for curl test evaluation is placed on a flat surface, and respective distances (distances in the height direction) from the flat surface to four corners of the sample are measured. Then, an average of these values is determined, and the average is taken as an “initial curl height”.

After the determination of the “initial curl height”, the sample for evaluation is left under the environment of 23° C. and 50% RH for 20 hours. After being left, the sample for evaluation is placed on a flat surface, and respective distances (distances in the height direction) from the flat surface to four corners of the sample are measured. Then, an average of these values is determined, and the average is taken as a “curl height after 20 hours”.

Then, a “difference in curl height” is determined from the difference between the “initial curl height” and the “curl height after 20 hours”.

The pressure-sensitive adhesive composition according to the present invention is not especially limited, and may be, for example, an acryl-based pressure-sensitive adhesive composition to form an acryl-based pressure-sensitive adhesive layer, a rubber-based pressure-sensitive adhesive composition to form a rubber-based pressure-sensitive adhesive layer, a vinyl alkyl ether-based pressure-sensitive adhesive composition to form a vinyl alkyl ether-based pressure-sensitive adhesive layer, a silicone-based pressure-sensitive adhesive composition to form a silicone-based pressure-sensitive adhesive layer, a polyester-based pressure-sensitive adhesive composition to form a polyester-based pressure-sensitive adhesive layer, a polyamide-based pressure-sensitive adhesive composition to form a polyamide-based pressure-sensitive adhesive layer, a urethane-based pressure-sensitive adhesive composition to form a urethane-based pressure-sensitive adhesive layer, a fluorine-based pressure-sensitive adhesive composition to form a fluorine-based pressure-sensitive adhesive layer, or an epoxy-based pressure-sensitive adhesive composition to form an epoxy-based pressure-sensitive adhesive layer.

Among these, the pressure-sensitive adhesive composition according to the present invention is preferably an acryl-based pressure-sensitive adhesive composition to form an acryl-based pressure-sensitive adhesive layer. In the present description, in the case where the pressure-sensitive adhesive composition according to the present invention is a removable water-dispersible acryl-based pressure-sensitive adhesive composition, the pressure-sensitive adhesive composition is referred to as the “acryl-based pressure-sensitive adhesive composition according to the present invention” in some cases.

The acryl-based pressure-sensitive adhesive composition according to the present invention contains at least an acryl emulsion-based polymer. The acryl-based pressure-sensitive adhesive composition according to the present invention preferably contains, at least, (i) the acryl emulsion-based polymer, (ii) a water-insoluble crosslinking agent, (iii) an acetylenediol-based compound, and (iv) an ether group-containing polysiloxane or a polyether-type defoaming agent, from the viewpoint of providing good curl regulatability.

It is preferable that particularly the acryl-based pressure-sensitive adhesive composition according to the present invention contains an acryl emulsion-based polymer, a water-insoluble crosslinking agent, an acetylenediol-based compound, and an ether group-containing polysiloxane or a polyether-type defoaming agent,

wherein the acryl emulsion-based polymer is constituted of an alkyl(meth)acrylate and a carboxyl group-containing unsaturated monomer as essential raw material monomers, wherein the content of the alkyl(meth)acrylate is 70 to 99.5% by weight with respect to the total amount of the raw material monomers, and the content of the carboxyl group-containing unsaturated monomer is 0.5 to 10.0% by weight with respect to the total amount of the raw material monomers; and

wherein a value (A) determined by the following expression (1) is 0.2 to 0.7, or a value (B) determined by the following expression (2) is 0.2 to 2.0.

Value(A)=(X)×(Y) (1)

Value(B)=(X)×(Z) (2)

X: a content of the water-insoluble crosslinking agent, which is expressed in an amount thereof (parts by weight) with respect to 100 parts by weight of the acryl emulsion-based polymer.

Y: a content of the ether group-containing polysiloxane, which is expressed in an amount thereof (parts by weight) with respect to 100 parts by weight of the acryl emulsion-based polymer.

Z: a content of the polyether-type defoaming agent, which is expressed in an amount thereof (parts by weight) with respect to 100 parts by weight of the acryl emulsion-based polymer.

### (Acryl Emulsion-Based Polymer)

As described above, the acryl-based pressure-sensitive adhesive composition according to the present invention contains at least an acryl emulsion-based polymer. The acryl emulsion-based polymer can be used singly or in a combination of two or more. In the present description, “(meth)acryl.” means “acryl and/or methacryl”.

The content of an acryl emulsion-based polymer in the acryl-based pressure-sensitive adhesive composition according to the present invention is not especially limited, but is preferably not less than 80% by weight, and more preferably not less than 85% by weight, with respect to the total amount in terms of solid content (total weight in terms of solid content, 100% by weight) of the acryl-based pressure-sensitive adhesive composition according to the present invention.

The acryl emulsion-based polymer is not especially limited as long as being a polymer formed by using an alkyl(meth)acrylate as an essential raw material monomer, but is preferably a polymer formed by using an alkyl(meth)acrylate and a carboxyl group-containing unsaturated monomer as essential raw material monomers. In other words, the acryl emulsion-based polymer preferably contains, at least, an alkyl(meth)acrylate and a carboxyl group-containing unsaturated monomer as constituting monomer components.

It is also preferable in the acryl emulsion-based polymer that the content of the alkyl(meth)acrylate is 70 to 99.5% by weight with respect to the total amount of the raw material monomers, and the content of the carboxyl group-containing unsaturated monomer is 0.5 to 10.0% by weight with respect to the total amount of the raw material monomers. In other words, it is preferable in the acryl emulsion-based polymer that the content of the alkyl(meth)acrylate is 70 to 99.5% by weight with respect to the total amount (total weight, 100% by weight) of the monomer components constituting the acryl emulsion-based polymer, and the content of the carboxyl group-containing unsaturated monomer is 0.5 to 10.0% by weight with respect to the total amount (total weight, 100% by weight) of the monomer components constituting the acryl emulsion-based polymer.

The alkyl(meth)acrylate is a main monomer component constituting an acryl emulsion-based polymer, and has a function of developing fundamental properties as a pressure-sensitive adhesive (or a pressure-sensitive adhesive layer), mainly such as the adhesivity and the peelability. Particularly, an alkyl acrylate is likely to impart the acryl emulsion-based polymer to become a base polymer with the flexibility, and to exhibit an effect of making the pressure-sensitive adhesive layer develop the close adhesion and the tackiness, and an alkyl methacrylate is likely to impart the acryl emulsion-based polymer to become a base polymer with the hardness, and to exhibit an effect of regulating the removability of the pressure-sensitive adhesive layer.

The alkyl(meth)acrylate is not especially limited, but preferably includes alkyl(meth)acrylates having the straight-chain, branched-chain or cyclic alkyl group having 1 to 20 carbon atoms. The alkyl(meth)acrylates can be used singly or in a combination of two or more.

Among these, the alkyl(meth)acrylate preferably includes alkyl acrylates having the straight-chain or branched-chain alkyl group having 1 to 16 carbon atoms. In the alkyl acrylates, the upper limit of the number of carbon atoms in the alkyl group is more preferably not more than 12, and still more preferably not more than 10. On the other hand, the lower limit of the number of carbon atoms in the alkyl group is more preferably not less than 2, and still more preferably not less than 4.

Examples of the alkyl acrylates having the straight-chain or branched-chain alkyl group include methyl acrylate, ethyl acrylate, propyl acrylate, 1-methylethyl acrylate, n-butyl acrylate, isobutyl acrylate, s-butyl acrylate, pentyl acrylate, isoamyl acrylate, hexyl acrylate, heptyl acrylate, octyl acrylate, 2-ethylhexyl acrylate, isooctyl acrylate, nonyl acrylate, isononyl acrylate, decyl acrylate, undecyl acrylate, dodecyl acrylate, tridecyl acrylate, pentadecyl acrylate and hexadecyl acrylate. Among these, 2-ethylhexyl acrylate and n-butyl acrylate are preferable. The alkyl acrylates having the straight-chain or branched-chain alkyl group can be used singly or in a combination of two or more.

The alkyl(meth)acrylate, further, preferably includes alkyl methacrylates having the alkyl group having 1 to 16 carbon atoms. In the alkyl methacrylates, the upper limit of the number of carbon atoms in the alkyl group is more preferably not more than 12, and still more preferably not more than 10.

Examples of the alkyl methacrylates include alkyl methacrylates having the straight-chain or branched-chain alkyl group, such as methyl methacrylate, ethyl methacrylate, propyl methacrylate, 1-methylethyl methacrylate, n-butyl methacrylate, isobutyl methacrylate, s-butyl methacrylate, t-butyl methacrylate, pentyl methacrylate, isoamyl methacrylate, hexyl methacrylate, heptyl methacrylate, octyl methacrylate, 2-ethylhexyl methacrylate, isooctyl methacrylate, nonyl methacrylate, isononyl methacrylate, decyl methacrylate, undecyl methacrylate, dodecyl methacrylate, tridecyl methacrylate, pentadecyl methacrylate and hexadecyl methacrylate. The alkyl methacrylates further include alicyclic alkyl methacrylates such as cyclohexyl methacrylate, bornyl methacrylate and isobornyl methacrylate. Among these, methyl methacrylate and butyl methacrylate are preferable. The alkyl methacrylates can be used singly or in a combination of two or more.

The acryl emulsion-based polymer preferably contains an alkyl acrylate and an alkyl methacrylate as alkyl(meth)acrylates as raw material monomers, from the viewpoint of simultaneously satisfying both the good removability and the good close adhesion with an adherend (particularly the close adhesion and the conformability with irregular surfaces), and providing the good appearance in a pressure-sensitive adhesive layer formed of the acryl-based pressure-sensitive adhesive composition according to the present invention. It is more preferable to incorporate particularly an alkyl acrylate having the straight-chain or branched-chain alkyl group and an alkyl methacrylate having the straight-chain or branched-chain alkyl group as raw material monomers; and it is still more preferable to incorporate at least one alkyl acrylate having the straight-chain or branched-chain alkyl group selected from the group consisting of 2-ethylhexyl acrylate and n-butyl acrylate, and at least one alkyl methacrylate having the straight-chain or branched-chain alkyl group selected from the group consisting of methyl methacrylate and butyl methacrylate.

In the case of concurrently using an alkyl acrylate and an alkyl methacrylate as raw material monomers for the acryl emulsion-based polymer, the proportion (in terms of weight) is not especially limited, but is, in (alkyl acrylate)/(alkyl methacrylate), preferably 99/1 to 70/30, and more preferably 99/1 to 80/20.

The content of the alkyl(meth)acrylate is not especially limited, but is preferably 70 to 99.5% by weight with respect to the total amount (all raw material monomers) (100% by weight) of the raw material monomers constituting an acryl emulsion-based polymer. The upper limit of the content of the alkyl(meth)acrylate is preferably not more than 99% by weight, and more preferably not more than 98% by weight. The lower limit thereof is preferably not less than 80% by weight, and more preferably not less than 85% by weight. If the content is less than 70% by weight, the adhesivity and the removability of a pressure-sensitive adhesive layer formed decrease in some cases. By contrast, if the content exceeds 99.5% by weight, due to decrease in the content of the carboxyl group-containing unsaturated monomer, the anchoring property, the low staining property and the stability of the emulsion of a pressure-sensitive adhesive layer formed decrease in some cases.

The acryl emulsion-based polymer preferably contains, in addition to the alkyl(meth)acrylate, a carboxyl group-containing unsaturated monomer as a raw material monomer. The carboxyl group-containing unsaturated monomer forms a protection layer on the surface of emulsion particles composed of an acryl emulsion-based polymer, and can exhibit a function of preventing shearing break of the particles. This is more improved by neutralizing the carboxyl group with a base. The stability to the shearing break of particles is more generally called the mechanical stability. A combination of one or two or more of polyfunctional compounds (for example, polyfunctional epoxy compounds) to react with the carboxyl group can also act as a crosslinking site in a stage of forming a pressure-sensitive adhesive layer by dehydration. The close adhesion (anchoring property) can also be improved through the polyfunctional compounds.

Examples of the carboxyl group-containing unsaturated monomer include (meth)acrylic acid (acrylic acid, methacrylic acid), itaconic acid, maleic acid, fumaric acid, crotonic acid, carboxyethyl acrylate and carboxypentyl acrylate. Carboxyl group-containing unsaturated monomers include acid anhydride group-containing unsaturated monomers such as maleic anhydride and itaconic anhydride. Among these, acrylic acid is preferable because of easily forming a protection layer high in the relative concentration on the particle surface and high in the density. The carboxyl group-containing unsaturated monomers can be used singly or in a combination of two or more.

The content of the carboxyl group-containing unsaturated monomer is not especially limited, but is preferably 0.5 to 10.0% by weight with respect to the total amount (all raw material monomers) (100% by weight) of the raw material monomers constituting the acryl emulsion-based polymer. The upper limit of the content of the carboxyl group-containing unsaturated monomer is more preferably not more than 5.0% by weight, and still more preferably not more than 4.0% by weight. The lower limit thereof is more preferably not less than 1.0% by weight, and still more preferably not less than 2.0% by weight. In the case where the content exceeds 10% by weight, since a carboxyl group-containing unsaturated monomer (for example, acrylic acid) is generally water-soluble, the monomer is polymerized in water and causes thickening (an increase in the viscosity) in some cases. Additionally, after a pressure-sensitive adhesive layer is formed of a pressure-sensitive adhesive composition, the interaction with functional groups on the surface of an adherend increases, and the pressure-sensitive adhesive force increases with time and peeling is made difficult to thereby reduce the removability in some cases. By contrast, in the case where the content is less than 0.5% by weight, the mechanical stability of the emulsion particles decreases in some cases. There are also some cases where the close adhesion (anchoring property) decreases and the adhesive residue is caused.

The acryl emulsion-based polymer may contain, as constituting monomer components (raw material monomers), “other monomers” (monomer components other than the alkyl(meth)acrylate and the carboxyl group-containing unsaturated monomer) for the purpose of imparting specific functions. The other monomers can be used singly or in a combination of two or more.

The acryl emulsion-based polymer, for the purpose of improving the cohesive force, may contain, as raw material monomers, for example, at least one of other monomers selected from the group consisting of amide group-containing monomers such as (meth)acrylamide, N,N-diethyl(meth)acrylamide and N-isopropyl(meth)acrylamide, and amino group-containing monomers such as N,N-dimethylaminoethyl(meth)acrylate and N,N-dimethylaminopropyl(meth)acrylate in 0.1 to 1.5% by weight with respect to the total amount (all raw material monomers) (100% by weight) of the raw material monomers constituting the acryl emulsion-based polymer.

The acryl emulsion-based polymer, for the purpose of regulating the refractive index and the reworkability, may further contain, as raw material monomers, at least one of other monomers selected from the group consisting of aryl(meth)acrylates such as phenyl(meth)acrylate; vinyl esters such as vinyl acetate and vinyl propionate; and styrene-based monomers such as styrene in not more than 15% by weight with respect to the total amount (all raw material monomers) (100% by weight) of the raw material monomers constituting the acryl emulsion-based polymer.

The acryl emulsion-based polymer, for the purpose of the crosslinking in the emulsion particles and improvement in the cohesive force, may further contain, as raw material monomers, at least one polyfunctional monomer selected from the group consisting of epoxy group-containing monomers such as glycidyl(meth)acrylate and ally glycidyl ether, trimethylolpropane tri(meth)acrylate and divinylbenzene in less than 5% by weight with respect to the total amount (all raw material monomers) (100% by weight) of the raw material monomers constituting the acryl emulsion-based polymer.

The acryl emulsion-based polymer, for the purpose of using a hydrazide-based crosslinking agent together to form hydrazide crosslinking and improving particularly the low staining property, may further contain, as raw material monomers, a keto group-containing unsaturated monomer such as diacetone acrylamide (DAAM), allyl actoacetate and 2-(acetoacetoxy)ethyl(meth)acrylate in less than 10% by weight (preferably 0.5 to 5% by weight) with respect to the total amount (all raw material monomers) (100% by weight) of the raw material monomers constituting the acryl emulsion-based polymer.

The other monomers additionally include hydroxyl group-containing unsaturated monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether and diethylene glycol monovinyl ether. The hydroxyl group-containing unsaturated monomers are used singly or in a combination of two or more.

The content of the hydroxyl group-containing unsaturated monomer is preferably low from the viewpoint of more reducing blushing (whitening) staining. Specifically, the content of the hydroxyl group-containing unsaturated monomer is preferably less than 1% by weight, and more preferably less than 0.1% by weight, with respect to the total amount (all raw material monomers) (100% by weight) of the raw material monomers constituting the acryl emulsion-based polymer, and is still more preferably substantially no content (for example, less than 0.05% by weight). However, in the case where the incorporation has a purpose of the introduction of crosslinking sites such as of crosslinking of a hydroxyl group and an isocyanate group, and metal crosslinking, the content may be 0.01 to 10% by weight.

Particularly the acryl emulsion-based polymer, from the viewpoint of improving the appearance of a pressure-sensitive adhesive sheet obtained from the acryl-based pressure-sensitive adhesive composition according to the present invention and a pressure-sensitive adhesive layer formed of the acryl-based pressure-sensitive adhesive composition according to the present invention, preferably contains, as constituting monomer components (raw material monomers), at least one monomer selected from the group consisting of methyl methacrylate, isobornyl acrylate, N,N-diethylacrylamide and vinyl acetate, and especially preferably contains methyl methacrylate. The content of the monomer (monomer selected from the group consisting of methyl methacrylate, isobornyl acrylate, N,N-diethylacrylamide and vinyl acetate) in the total amount (all raw material monomers) (100% by weight) of the raw material monomers constituting the acryl emulsion-based polymer is preferably 0.5 to 15% by weight, more preferably 1 to 10% by weight, and still more preferably 2 to 5% by weight. If the content is less than 0.5% by weight, the effect of improving the appearance cannot be provided in some cases; and by contrast, if the content exceeds 15% by weight, a decrease in the close adhesion of a pressure-sensitive adhesive layer formed of the pressure-sensitive adhesive composition is caused in some cases. In the case where raw material monomers constituting an acryl emulsion-based polymer contain two or more monomers selected from the group consisting of methyl methacrylate, isobornyl acrylate, N,N-diethylacrylamide and vinyl acetate, it suffices if the total amount (total content) of contents of methyl methacrylate, isobornyl acrylate, N,N-diethylacrylamide and vinyl acetate meets the above range.

The acryl emulsion-based polymer is obtained by polymerizing the raw material monomers. Specifically, the acryl emulsion-based polymer is preferably obtained by polymerizing a mixture (monomer mixture) containing at least the raw material monomers. A polymerization method thereof is not especially limited, but is preferably an emulsion polymerization. The acryl emulsion-based polymer is preferably obtained, for example, by emulsion-polymerizing a mixture containing the raw material monomers and an emulsifying agent (surfactant). The mixture, as required, may contain a polymerization initiator, and may contain a chain transfer agent from the viewpoint of regulating the molecular weight of the acryl emulsion-based polymer.

The emulsifying agent is not especially limited, but is preferably a reactive emulsifying agent (reactive surfactant) from the viewpoint of reducing stains originated from the emulsifying agent. The reactive emulsifying agent refers to an emulsifying agent having a reactivity and reacting with raw material monomers to be incorporated in a polymer. The emulsifying agent can be used singly or in a combination of two or more.

The reactive emulsifying agent is not especially limited, but is preferably a reactive emulsifying agent having a radical polymerizable functional group in the molecule. That is, the acryl emulsion-based polymer is preferably a polymer polymerized using a reactive emulsifying agent having a radical polymerizable functional group in the molecule. In the present description, a “reactive emulsifying agent having a radical polymerizable functional group in the molecule” is simply referred to as a “reactive emulsifying agent” in some cases.

Examples of the radical polymerizable functional group in the reactive emulsifying agent having the radical, polymerizable functional group in the molecule include a vinyl group, a propenyl group, an isopropenyl group, a vinyl ether group (vinyloxy group) and an allyl ether group (allyloxy group).

Examples of the reactive emulsifying agent include reactive emulsifying agents having a form (or, corresponding to the form) in which a radical polymerizable functional group (radical reactive group), such as a propenyl group and an ally ether group, is incorporated in a nonionic-anionic emulsifying agent (anionic emulsifying agent having a nonionic hydrophilic group), such as sodium polyoxyethylene alkyl ether sulfate, ammonium polyoxyethylene alkyl phenyl ether sulfate, sodium polyoxyethylene alkyl phenyl ether sulfate and sodium polyoxyethylene alkyl sulfosuccinate. In the present description, a reactive emulsifying agent having a form in which an anionic emulsifying agent has a radical polymerizable functional group incorporated therein is referred to as an “anionic reactive emulsifying agent” in some cases; and a reactive emulsifying agent having a form in which a nonionic-anionic emulsifying agent has a radical polymerizable functional group incorporated therein is referred to as a “nonionic-anionic reactive emulsifying agent” in some cases.

The reactive emulsifying agent is preferably an anionic reactive emulsifying agent, and more preferably a nonionic-anionic reactive emulsifying agent, particularly from the viewpoint of being capable of more improving the low staining property.

The anionic reactive emulsifying agent (particularly the nonionic-anionic reactive emulsifying agent), in the case where a water-insoluble crosslinking agent described later is a polyfunctional epoxy-based crosslinking agent having an epoxy group, can improve the reactivity of the crosslinking agent by its catalytic action. In the case where the anionic reactive emulsifying agent is not used, in a pressure-sensitive adhesive layer formed of an acryl-based pressure-sensitive adhesive composition, the crosslinking reaction is not completed by aging, and there arises the problem of the pressure-sensitive adhesive force changing with time in some cases. A further problem that arises in some cases is that the pressure-sensitive adhesive force with an adherend rises with time due to unreacted carboxyl groups. Since the anionic reactive emulsifying agent is incorporated in a polymer, and resultantly does not deposit on the surface of an adherend as would be seen in a quaternary ammonium compound, usually used as a catalyst of an epoxy-based crosslinking agent, (for example, see Japanese Patent Laid-Open No. 2007-31585), the anionic reactive emulsifying agent cannot make a cause of blushing staining, which is therefore preferable.

As such reactive emulsifying agents, there can also be used commercially available products such as trade names “Adeka Reasoap SE-100N”, “Adeka Reasoap SE-20N”, “Adeka Reasoap SR-10” and “Adeka Reasoap SR-20” (made by Adeka Corp.), trade names “Aquaron HS-05”, “Aquaron HS-10” and “Aquaron HS-1025” (made by Daiichi Kogyo Seiyaku Co., Ltd.), and trade name “Latemul PD-104” (made by Kao Corp.).

The amount of the emulsifying agent blended (used) in a mixture containing the raw material monomers when the acryl emulsion-based polymer is obtained is not especially limited, but is preferably 0.1 to 10 parts by weight with respect to 100 parts by weight of the total amount (all raw material monomers) of the raw material monomers constituting the acryl emulsion-based polymer. For example, in the case where the emulsifying agent is the reactive emulsifying agent, the blend amount (use amount) thereof, with respect to 100 parts by weight of the total amount (all raw material monomers) of the raw material monomers constituting the acryl emulsion-based polymer, is preferably 0.1 to 10 parts by weight, more preferably 0.5 to 6 parts by weight, and still more preferably 1.0 to 4.5 parts by weight. If the blend amount is too small, stable emulsification cannot be maintained in some cases. By contrast, if the blend amount is too large, the cohesive force of a pressure-sensitive adhesive (pressure-sensitive adhesive layer) formed of an acryl-based pressure-sensitive adhesive composition decreases to thereby increase the staining amount on an adherend and cause staining due to the emulsifying agent in some cases.

As described above, in the mixture containing the raw material monomers to provide the acryl emulsion-based polymer, as required, a polymerization initiator may be contained. The polymerization initiator is not especially limited, but examples thereof include azo-based polymerization initiators such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate salts and 2,2′-azobis(N,N′-dimethyleneisobutylamidine); persulfate salts such as potassium persulfate and ammonium persulfate; peroxide-based polymerization initiators such as benzoyl peroxide, t-butyl hydroperoxide and hydrogen peroxide; and redox-type initiators in combinations of a peroxide and a reducing agent. Examples of the redox-type initiators include combinations of a peroxide and ascorbic acid (a combination of a hydrogen peroxide aqueous solution and ascorbic acid, or the like), combinations of a peroxide and an iron (II) salt (a combination of a hydrogen peroxide aqueous solution and an iron (II) salt, or the like) and combinations of a persulfate salt and a sodium hydrogensulfite. The polymerization initiators can be used singly or in a combination of two or more.

The amount of the polymerization initiator blended (used) in a mixture containing the raw material monomers when the acryl emulsion-based polymer is obtained is not especially limited, but is preferably 0.01 to 1 part by weight, and more preferably 0.02 to 0.5 part by weight, with respect to 100 parts by weight of the total amount (all raw material monomers) of the raw material monomers constituting the acryl emulsion-based polymer.

As described above, in a mixture containing the raw material monomers to provide the acryl emulsion-based polymer, a chain transfer agent may be contained from the viewpoint of regulating the molecular weight of the acryl emulsion-based polymer. The chain transfer agent is not especially limited, but examples thereof include lauryl mercaptan, glycidyl mercaptan, mercaptoacetic acid, 2-mercaptoethanol, thioglycolic acid, 2-ethylhexylthioglycolate and 2,3-dimethylcapto-1-propanol. The chain transfer agent can be used singly or in a combination of two or more.

The amount of the chain transfer agent blended (used) in a mixture containing the raw material monomers when the acryl emulsion-based polymer is obtained is not especially limited, but is preferably 0.001 to 0.5 parts by weight with respect to 100 parts by weight of the total amount (all raw material monomers) of the raw material monomers constituting the acryl emulsion-based polymer.

The emulsion polymerization when the acryl emulsion-based polymer is obtained can use any method such as usual batch polymerization, continuous dropping polymerization and divided dropping polymerization, which is not especially limited. From the viewpoint of low staining, the polymerization is desirably carried out by the batch polymerization and at a low temperature (for example, not more than 55° C., preferably not more than 30° C.). If the polymerization is carried out under such a condition, it is presumed that since high-molecular weight materials are easily obtained, and low-molecular weight materials become little, the staining is reduced.

The solvent-insoluble content (the proportion of solvent-insoluble components, sometimes referred to as “gel fraction”) of the acryl emulsion-based polymer is not especially limited, but is preferably not less than 70% (% by weight), more preferably not less than 75% by weight, and still more preferably not less than 80% by weight. If the solvent-insoluble content is less than 70% by weight, since an acryl emulsion-based polymer (A) contains much of low-molecular weight materials, and only the crosslinking effect therefore cannot sufficiently reduce the low-molecular weight components in a pressure-sensitive adhesive layer, adherend staining originated from the low-molecular weight components or the like is caused and the pressure-sensitive adhesive force becomes too high in some cases. The solvent-insoluble content can be controlled by the kinds of polymerization initiators, the reaction temperature, emulsifying agents, raw material monomers, and the like. The upper limit of the solvent-insoluble content is not especially limited, but is, for example, 99% by weight.

The solvent-insoluble content of the acryl emulsion-based polymer is a value calculated by the following “measurement method of a solvent-insoluble content”.

(a Measurement Method of a Solvent-Insoluble Content)

About 0.1 g of an acryl emulsion-based polymer is sampled, wrapped in a porous tetrafluoroethylene sheet (trade name: “NTF1122”, made by Nitto Denko Corp.) of 0.2 μm in average pore diameter, and thereafter bound by a kite string; and the weight at this time is weighed, and taken as a before-immersion weight. Here, the before-immersion weight is a total weight of the acryl emulsion-based polymer (the polymer sampled in the above), the tetrafluoroethylene sheet and the kite string. The total weight of the tetrafluoroethylene sheet and the kite string is also measured in advance, and taken as a tare weight.

Then, the acryl emulsion-based polymer wrapped with the tetrafluoroethylene sheet and bound by the kite string (referred to as “sample”) is put in a 50-ml vessel filled with ethyl acetate, and allowed to stand still at 23° C. for 7 days. Thereafter, the sample was taken out from the vessel (after the treatment with ethyl acetate), moved to an aluminum cup, dried in a drier at 130° C. for 2 hours to evaporate ethyl acetate, and then measured for the weight, which is taken as an after-immersion weight.

Then, the solvent-insoluble content is calculated from the following expression.

Solvent-insoluble content(% by weight)=(a−b)/(c−b)×100

In the above expression, a is the after-immersion weight; b is the tare weight; and c is the before-immersion weight.

### (Water-Insoluble Crosslinking Agent)

As described above, the acryl-based pressure-sensitive adhesive composition according to the present invention preferably contains at least a water-insoluble crosslinking agent. The water-insoluble crosslinking agent is insoluble to water, and is a compound having two or more functional groups capable of reacting with carboxyl groups in the molecule (one molecule). The water-insoluble crosslinking agent can be used singly or in a combination of two or more.

The incorporation of a water-insoluble crosslinking agent in the acryl-based pressure-sensitive adhesive composition according to the present invention can raise the crosslinking density of a pressure-sensitive adhesive layer formed and make high the rigidity of the pressure-sensitive adhesive layer. Good curl regulatability is resultantly easily provided in the pressure-sensitive adhesive layer formed. The crosslinking density of the pressure-sensitive adhesive layer formed can further be raised, and a rise with time of the pressure-sensitive adhesive force between the pressure-sensitive adhesive layer and an adherend can be prevented. Further since an acryl emulsion-based polymer as a base polymer is restrained in a pressure-sensitive adhesive layer, functional groups (particularly carboxyl groups) in the pressure-sensitive adhesive layer segregate on the adherend surface, and a rise with time of the pressure-sensitive adhesive force between the pressure-sensitive adhesive layer and the adherend can be prevented. Since the rise with time of the pressure-sensitive adhesive force between the pressure-sensitive adhesive layer formed and the adherend can be thus prevented, the good removability in the pressure-sensitive adhesive layer formed is easily provided.

Additionally, wetting spread of the pressure-sensitive adhesive layer formed can be prevented.

The number of functional groups capable of reacting with carboxyl groups in the water-insoluble crosslinking agent is not especially limited as long as being two or more, but is preferably 2 to 6, more preferably 2 to 5, and still more preferably 3 to 5. If the number of the functional groups capable of reacting with carboxyl groups is too large, gelated substances are produced in some cases, which is not preferable.

The functional group capable of reacting with a carboxyl group of a water-insoluble crosslinking agent is not especially limited, but examples thereof include an epoxy group, an isocyanate group and a carbodiimide group. Among these, an epoxy group is preferable and a glycidylamino group is more preferable, from the viewpoint of hardly remaining unreacted substances in the crosslinking reaction due to the high reactivity, which is advantageous in the low staining, and from the viewpoint of preventing a rise with time of the pressure-sensitive adhesive force with an adherend due to unreacted carboxyl groups in a pressure-sensitive adhesive layer, and thus providing the good removability. That is, a water-insoluble crosslinking agent is preferably an epoxy-based crosslinking agent having an epoxy group as a functional group capable of reacting with a carboxyl group, and more preferably a crosslinking agent (glycidylamino-based crosslinking agent) having a glycidylamino group as a functional group capable of reacting with a carboxyl group. In the case where the water-insoluble crosslinking agent is an epoxy-based crosslinking agent (particularly a glycidylamino-based crosslinking agent), the number of an epoxy group (particularly a glycidylamino group) in one molecule thereof is two or more, preferably 2 to 6, more preferably 2 to 5, and still more preferably 3 to 5.

The water-insoluble crosslinking agent is a water-insoluble compound. Here, “water-insoluble” refers to that the solubility to 100 parts by weight of water at 25° C. (the weight of a compound (crosslinking agent) soluble in 100 parts by weight of water) is not more than 5 parts by weight, and preferably not more than 3 parts by weight, and still more preferably not more than 2 parts by weight. The use of a water-insoluble crosslinking agent hardly causes the crosslinking agent remaining without being crosslinked to generate blushing staining on an adherend in a high-humidity environment, and improves the low staining property. In the case where the crosslinking is carried out using a water-soluble crosslinking agent alone, since the remaining crosslinking agent is dissolved in the moisture and easily transferred on an adherend in a high-humidity environment, the blushing staining is liable to be caused. A water-insoluble crosslinking agent, as compared with a water-soluble crosslinking agent, exhibits a high contribution to the crosslinking reaction (reaction with carboxyl groups) and provides a high effect of preventing a rise with time of the pressure-sensitive adhesive force. Further since a water-insoluble crosslinking agent has a high reactivity in the crosslinking reaction, the crosslinking reaction quickly progresses by aging and a rise with time of the pressure-sensitive adhesive force with an adherend due to unreacted carboxyl groups in a pressure-sensitive adhesive layer can be prevented. If the rise with time of the pressure-sensitive adhesive force of the pressure-sensitive adhesive layer can be prevented, the good removability is easily provided.

Here, the solubility of the crosslinking agent to water can be measured, for example, as follows.

(a Method for Measuring the Solubility to Water)

Water (25° C.) and a crosslinking agent in the same weight are mixed using a stirrer under conditions of a rotation frequency of 300 rpm and for 10 min, and centrifugally separated into a water phase and an oil phase. Then, the water phase is sampled, and dried at 120° C. for 1 hour; and the nonvolatile content in the water phase (parts by weight of nonvolatile components with respect to 100 parts by weight of water) is determined from the drying loss weight.

The water-insoluble crosslinking agent specifically includes glycidylamino-based crosslinking agents such as 1,3-bis(N,N-diglycidylaminomethyl)cyclohexane (for example, made by Mitsubishi Gas Chemical Co., Ltd., trade name: “TETRAD-C” and the like) [the solubility to 100 parts by weight of water at 25° C. is not more than 2 parts by weight], 1,3-bis(N,N-diglycidylaminomethyl)benzene (for example, made by Mitsubishi Gas Chemical Co., Ltd., trade name: “TETRAD-X” and the like) [the solubility to 100 parts by weight of water at 25° C. is not more than 2 parts by weight]; and tris(2,3-epoxypropyl) isocyanurate (for example, made by Nissan Chemical Industries, Ltd., trade name: “TEPIC-G” and the like) [the solubility to 100 parts by weight of water at 25° C. is not more than 2 parts by weight].

When the water-insoluble crosslinking agent is blended in the preparation of the acryl-based pressure-sensitive adhesive composition according to the present invention, the water-insoluble crosslinking agent may be added (blended) as it is in liquid form, or may be added by dissolving in and/or diluting with an organic solvent (here, the use amount of the organic solvent is preferably as small as possible). A method of adding a water-insoluble crosslinking agent by emulsifying with an emulsifying agent causes bleeding of the emulsifying agent to easily cause staining (particularly blushing staining), which is therefore not preferable.

As described above, the acryl-based pressure-sensitive adhesive composition according to the present invention preferably contains an acryl emulsion-based polymer, a water-insoluble crosslinking agent, an acetylenediol-based compound, and an ether group-containing polysiloxane or a polyether-type defoaming agent; and the content of the water-insoluble crosslinking agent in the acryl-based pressure-sensitive adhesive composition according to the present invention is not especially limited, but is, from the viewpoint of providing a pressure-sensitive adhesive layer formed with good curl regulatability, preferably an amount of a value (A) determined by the following expression (1) of 0.2 to 0.7, or an amount of a value (B) determined by the following expression (2) of 0.2 to 2.0, wherein in the value (A) and the value (B), the content of the water-insoluble crosslinking agent is taken to be X parts by weight with respect to 100 parts by weight of the acryl emulsion-based polymer; the content of the ether group-containing polysiloxane is taken to be Y parts by weight with respect to 100 parts by weight of the acryl emulsion-based polymer; and the content of the polyether-type defoaming agent is taken to be Z parts by weight with respect to 100 parts by weight of the acryl emulsion-based polymer.

Value(A)=(X)×(Y) (1)

Value(B)=(X)×(Z) (2)

Specifically, the content of the water-insoluble crosslinking agent is preferably 0.8 to 7.0 parts by weight with respect to 100 parts by weight of the acryl emulsion-based polymer. The upper limit of the content of the water-insoluble crosslinking agent is more preferably not more than 6.0 parts by weight, and still more preferably not more than 5.0 parts by weight. The lower limit thereof is more preferably not less than 1.0 parts by weight, and still more preferably not less than 1.5 parts by weight. If the content of the water-insoluble crosslinking agent is not less than 1.5 parts by weight, the crosslinking density of a pressure-sensitive adhesive layer formed of a pressure-sensitive adhesive composition can be raised, the rigidity of the pressure-sensitive adhesive layer can be made high, and the good curl regulatability is easily provided, which is preferable. A rise with time of the pressure-sensitive adhesive force between the pressure-sensitive adhesive layer formed of the pressure-sensitive adhesive composition and an adherend can be prevented, and the good removability is resultantly easily provided in the pressure-sensitive adhesive layer formed of the pressure-sensitive adhesive composition, which is preferable. On the other hand, if the content of the water-insoluble crosslinking agent is not more than 5.0 parts by weight, the water-insoluble crosslinking agent remaining without being crosslinked in a pressure-sensitive adhesive layer formed of a pressure-sensitive adhesive composition would be effectively prevented from causing staining, which is preferable.

### (Acetylenediol-Based Compound)

As described above, the acryl-based pressure-sensitive adhesive composition according to the present invention preferably contains at least an acetylenediol-based compound. The incorporation of an acetylenediol-based compound in the acryl-based pressure-sensitive adhesive composition according to the present invention makes the generation of appearance defects due to recess faults originated from the water-insoluble crosslinking agent in a pressure-sensitive adhesive layer formed of the pressure-sensitive adhesive composition to be easily suppressed. This is presumably because the acetylenediol-based compound acts for improvement in the dispersibility of the water-insoluble crosslinking agent in the acryl-based pressure-sensitive adhesive composition and the leveling effect in the formation time of the pressure-sensitive adhesive layer. The acetylenediol-based compound can be used singly or in a combination of two or more.

Examples of the acetylenediol-based compound include compounds represented by the following formula (I).

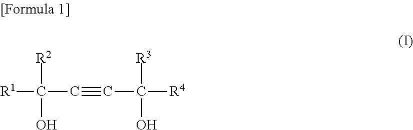

In the above formula (I), R¹, R², R³ and R⁴ denote a hydrocarbon group having 1 to 20 carbon atoms, and may contain a heteroatom; and R¹, R², R³ and R⁴ may be identical to or different from one another.

R¹, R², R³ and R⁴ in the above formula (I) may have either structure of straight chain or branched chain.

Among these, in the above formula (I), R¹ and R⁴ are preferably an alkyl group having 2 to 10 carbon atoms, and especially preferably a n-butyl group, sec-butyl group, tert-butyl group or isobutyl group having 4 carbon atoms; and R² and R³ are preferably an alkyl group having 1 to 4 carbon atoms, and especially preferably a methyl group or ethyl group having 1 or 2 carbon atoms.

Specific examples of the acetylenediol-based compound represented by the above formula (I) include 7,10-dimethyl-8-hexadecine-7,10-diol, 4,7-dimethyl-5-decine-4,7-diol, 2,4,7,9-tetramethyl-5-decine-4,7-diol and 3,6-dimethyl-4-octyne-3,6-diol.

When an acetylenediol-based compound represented by the above formula (I) is blended in the preparation time of the acryl-based pressure-sensitive adhesive composition according to the present invention, the acetylenediol-based compound represented by the above formula (I) dispersed or dissolved in various types of solvents may be used. Examples of such solvents include 2-ethylhexanol, butyl cellosolve, dipropylene glycol, ethylene glycol, propylene glycol, normal propyl alcohol and isopropanol. Among these, ethylene glycol and propylene glycol are preferable from the viewpoint of the dispersibility in an emulsion system. The solvent content, with respect to an acetylenediol-based compound dispersed or dissolved in the solvent at the time of blending (1.00% by weight), is preferably less than 40% by weight (for example, 15 to 35% by weight) for the case of using ethylene glycol as the solvent, and is preferably less than 70% by weight (for example, 20 to 60% by weight) for the case of using propylene glycol as the solvent.

An acetylenediol-based compound represented by the above formula (I) may be a commercially available product. An example of such a commercially available product includes Surfynol 104 series, made by Air Products and Chemicals, Inc. More specific examples thereof include “Surfynol 104E”, “Surfynol 104H”, “Surfynol 104A”, “Surfynol 104BC”, “Surfynol 104DPM”, “Surfynol 104PA” and “Surfynol 104PG-50”.

Examples of the acetylenediol-based compound further include compounds represented by the following formula (II).

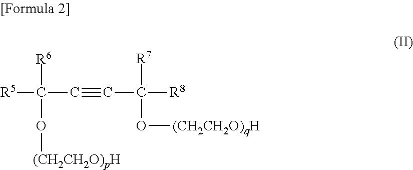

R⁵, R⁶, R⁷ and R⁸ in the above formula (II) denote a hydrocarbon group having 1 to 20 carbon atoms, and may contain a heteroatom; R⁵, R⁶, R⁷ and R⁸ may be identical to or different from one another; p and q in the above formula (II) are an integer of not less than 0, and the sum [p+q] of p and q is not less than 1, and is preferably 1 to 20, and more preferably 1 to 9; p and q may be identical to or different from each other; p and q are numbers so regulated that the HLB value of an acetylenediol-based compound (C) becomes less than 13; and in the case where p is 0, [—O—(CH₂CH₂O)ₚH] is a hydroxyl group [—OH], and for q, the same is applied.

R⁵, R⁶, R⁷ and R⁸ in the above formula (II) may have either structure of straight chain or branched chain. Among these, R⁵ and R⁸ are preferably an alkyl group having 2 to 10 carbon atoms, and especially preferably a n-butyl group, sec-butyl group, tert-butyl group or isobutyl group having 4 carbon atoms; and R⁶ and R⁷ are preferably an alkyl group having 1 to 4 carbon atoms, and especially preferably a methyl group or ethyl group having 1 or 2 carbon atoms.

Specific examples of the acetylenediol-based compound represented by the above formula (II) include ethylene oxide adducts of 7,10-dimethyl-8-hexadecine-7,10-diol, ethylene oxide adducts of 4,7-dimethyl-5-decine-4,7-diol, ethylene oxide adducts of 2,4,7,9-tetramethyl-5-decine-4,7-diol, and ethylene oxide adducts of 3,6-dimethyl-4-octyne-3,6-diol. Here, an average number of addition moles of ethylene oxide of the ethylene oxide adducts of 2,4,7,9-tetramethyl-5-decine-4,7-diol is preferably not more than 9.

p and q in the above formula (II) are numbers so regulated that the HLB value of an acetylenediol-based compound becomes less than 13. For example, in the case where an acetylenediol-based compound represented by the above formula (II) is an ethylene oxide adduct of 2,4,7,9-tetramethyl-5-decine-4,7-diol, the total of p and q is preferably not more than 9.

When an ethylene oxide-added acetylenediol-based compound as an acetylenediol-based compound represented by the above formula (II) is blended in the preparation time of the acryl-based pressure-sensitive adhesive composition according to the present invention, the compound alone without using a solvent is preferably blended, but for the purpose of improving the blending workability, the acetylenediol-based compound dispersed or dissolved in various types of solvents may be used. The solvent includes 2-ethylhexanol, butyl cellosolve, dipropylene glycol, ethylene glycol, propylene glycol, normal propyl alcohol and isopropanol. Among these solvents, ethylene glycol and propylene glycol are preferably used from the viewpoint of the dispersibility in an emulsion system.

An acetylenediol-based compound represented by the above formula (II) may be a commercially available product. An example of such a commercially available product includes Surfynol 400 series, made by Air Products and Chemicals, Inc. More specific examples thereof include “Surfynol 420” and “Surfynol 440”.

The HLB value (simply referred to as “HLB” in some cases) of the acetylenediol-based compound is less than 13, preferably 1 to 10, more preferably 3 to 8, and still more preferably 3 to 5. With the HLB value of not less than 13, the staining property to an adherend is worsened. The HLB value represents Hydrophile-Lipophile Balance by Griffin, and is a value representing a degree of the affinity of a surfactant for water or oil. The definition of the HLB value is described in W. C. Griffin, J. Soc, Cosmetic Chemists, 1, 311 (1949); Coauthors: Koshitami Takahashi, Yoshirou Nanba, Motoo Koike and Masao Kobayashi, “Surfactant Handbook”, 3rd ed., published by Kogakutosho Co., Ltd., Nov. 25, 1972, pp. 179-182 (in Japanese); and the like.

The content of the acetylenediol-based compound in the acryl-based pressure-sensitive adhesive composition according to the present invention is not especially limited, but with respect to 100 parts by weight of the acryl emulsion-based polymer, is preferably 0.01 to 10 parts by weight, more preferably 0.1 to 7 parts by weight, and still more preferably 0.5 to 5 parts by weight. If the content of the acetylenediol-based compound is not less than 0.01 part by weight, appearance defects due to recess faults of the water-insoluble crosslinking agent can be effectively suppressed, which is preferable. On the other hand, if the content of the acetylenediol-based compound is not more than 10 parts by weight, the staining to an adherend by the acetylenediol-based compound can be effectively suppressed, which is preferable.

### (Ether Group-Containing Polysiloxane)

As described above, the acryl-based pressure-sensitive adhesive composition according to the present invention preferably contains an ether group-containing polysiloxane or a polyether-type defoaming agent from the viewpoint of simultaneously satisfying both the easy peelability and the curl regulatability. The ether group-containing polysiloxane is a polysiloxane having an ether bond in the molecule (one molecule). The ether group-containing polysiloxane can be used singly or in a combination of two or more.

Examples of the ether group-containing polysiloxane include compounds represented by the following formula (III).

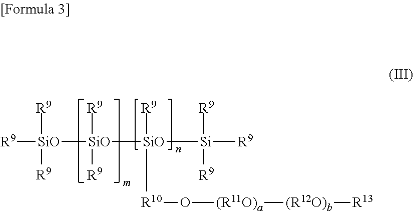

R⁹ in the above formula (III) denotes a monovalent organic group; R¹⁰, R¹¹ and R¹² denote an alkylene group; R¹³ denotes a hydroxide group or an organic group; m is an integer of 0 to 1,000; n is an integer of 1 to 1,000; and a and b are an integer of 0 to 100, and a and b are not 0 at the same time.

The R⁹ preferably includes alkyl groups such as a methyl group, an ethyl group and a propyl group; aryl groups or a benzyl group such as a phenyl group and a tolyl group; and a phenethyl group. The R⁹ may be a monovalent organic group containing a substituent such as a hydroxide group.

The R¹⁰, R¹¹ and R¹² preferably include alkylene groups having 1 to 8 carbon atoms such as a methylene group, an ethylene group and a propylene group. The R¹⁰, R¹¹ and R¹² may contain a substituent such as a hydroxide group.

The R¹³, in the case of being an organic group, preferably includes monovalent organic groups (for example, an alkyl group such as a methyl group and a propyl group, or an acyl group such as an acetyl group or a propionyl group), and may be a monovalent organic group containing a substituent such as a hydroxide group.

The ether group-containing polysiloxane may further contain a reactive substituent such as a (meth)acryloyl group, an allyl group or a hydroxide group in the molecule.

In the case where the acryl-based pressure-sensitive adhesive composition according to the present invention contains an acryl emulsion-based polymer, a water-insoluble crosslinking agent, an acetylenediol-based compound, and an ether group-containing polysiloxane, the content of the ether group-containing polysiloxane in the acryl-based pressure-sensitive adhesive composition according to the present invention is not especially limited, but is, from the viewpoint of providing a pressure-sensitive adhesive layer formed with good curl regulatability, preferably an amount of a value (A) determined by the following expression (1) of 0.2 to 0.7, wherein in the value (A), the content of the water-insoluble crosslinking agent is taken to be X parts by weight with respect to 100 parts by weight of the acryl emulsion-based polymer; and the content of the ether group-containing polysiloxane is taken to be Y parts by weight with respect to 100 parts by weight of the acryl emulsion-based polymer.

Value(A)=(X)×(Y) (1)

Specifically, the content of the ether group-containing polysiloxane is, with respect to 100 parts by weight of the acryl emulsion-based polymer, preferably 0.008 to 1.0 part by weight. The upper limit of the content of the ether group-containing polysiloxane is more preferably not more than 1.0 part by weight, and still more preferably not more than 0.7 part by weight. The lower limit thereof is more preferably not less than 0.01 part by weight, and still more preferably not less than 0.05 part by weight. If the content of the ether group-containing polysiloxane is not less than 0.008 part by weight, a rise with time of the pressure-sensitive adhesive force between a pressure-sensitive adhesive layer formed of a pressure-sensitive adhesive composition and an adherend can be prevented, and the good removability in the pressure-sensitive adhesive layer formed of the pressure-sensitive adhesive composition is easily provided, which is therefore preferable. On the other hand, if the content of the ether group-containing polysiloxane is not more than 1.0 part by weight, the ether group-containing polysiloxane is effectively prevented from causing staining in a pressure-sensitive adhesive layer formed of a pressure-sensitive adhesive composition, which is preferable.

### (Polyether-Type Defoaming Agent)

As described above, the acryl-based pressure-sensitive adhesive composition according to the present invention preferably contains an ether group-containing polysiloxane or a polyether-type defoaming agent. The incorporation of a polyether-type defoaming agent in the acryl-based pressure-sensitive adhesive composition according to the present invention can prevent a rise with time of the pressure-sensitive adhesive force between a pressure-sensitive adhesive layer formed of the pressure-sensitive adhesive composition and an adherend, and easily provides the pressure-sensitive adhesive layer formed of the pressure-sensitive adhesive composition with the good removability, and further brings about an advantage in that the coated appearance of the pressure-sensitive adhesive composition becomes good due to the defoaming effect. The polyether-type defoaming agent can be used singly or in a combination of two or more.

The polyether-type defoaming agent is preferably at least one compound selected from the group consisting of compounds represented by the following formula (IV), compounds represented by the following formula (V) and compounds represented by the following formula (VI). The polyether-type defoaming agent can be obtained, for example, by reacting a fatty acid or a higher alcohol with propylene oxide or ethylene oxide and propylene oxide. The polyether-type defoaming agent can also be obtained by reacting ethylene glycol and propylene glycol.

In the present description, PO denotes an oxypropylene group [—CH₂CH(CH₃)O—], and EO denotes an oxyethylene group [—CH₂CH₂O—].

The polyether-type defoaming agent preferably includes compounds represented by the following formula (IV).

R^{a}O—(PO)ₙ₁(EO)ₘ₁—CO—R^{b} (IV)

In the above formula (IV), R^{a} denotes an alkyl group or alkenyl group having 8 to 22 carbon atoms or an alkylcarbonyl group or alkenylcarbonyl group having 8 to 21 carbon atoms; and Rb denotes an alkyl group or alkenyl group having 8 to 21 carbon atoms.

In the above formula (IV), PO denotes an oxypropylene group, and EO denotes an oxyethylene group; n1 is an integer of not less than 1, and is suitably regulated so that the PO content of a polyether-type defoaming agent becomes 70 to 100% by weight, but is, for example, preferably 2 to 50; and m1 denotes an integer of 0 to 15 (preferably an integer of 2 to 10), and in the case where m1 is 0, the formula (IV) is represented by R^{a}O— (PO)ₙ₁—CO—R^{b}.

In the above formula (IV), the addition form (copolymerization form) of EO and PO is a random type (in random form) or a block type (in block form). The arrangement of each block in the case of the block type addition form is, for example, (a block composed of EO)-(a block composed of PO)-(a block composed of EO), (a block composed of PO)-(a block composed of EO)-(a block composed of PO), (a block composed of EO)-(a block composed of PO) or (a block composed of PO)-(a block composed of EO).

The polyether-type defoaming agent, further, preferably includes compounds represented by the following formula (V).

R^{c}O—(PO)ₙ₂(EO)ₘ₂—H (V)

In the above formula (V), R^{c} denotes a nonylphenyl group, an actylphenyl group or an alkyl group or alkenyl group having 8 to 22 carbon atoms.

In the above formula (V), PO denotes an oxypropylene group, and EO denotes an oxyethylene group; n2 is an integer of not less than 1, and is suitably regulated so that the PO content of a polyether-type defoaming agent becomes 70 to 100% by weight, but is, for example, preferably 10 to 40; and m2 denotes an integer of 0 to 20 (preferably an integer of 2 to 10), and in the case where m2 is 0, the formula (V) is represented by R^{c}O—(PO)ₙ₂—H.

In the above formula (V), the addition form (copolymerization form) of EO and PO is a random type (in random form) or a block type (in block form). The arrangement of each block in the case of the block type addition form is, for example, (a block composed of EO)-(a block composed of PO) or (a block composed of PO)-(a block composed of EO).

The polyether-type defoaming agent includes, for example, compounds represented by the following formula (VI).

HO—(PO)ₙ₃(EO)ₘ₃—H (VI)

In the above formula (VI), PO denotes an oxypropylene group, and EO denotes an oxyethylene group; n3 is an integer of not less than 1, and is suitably regulated so that the PO content of a polyether-type defoaming agent (D) becomes 70 to 100% by weight, but is, for example, preferably 10 to 69; and m3 denotes an integer of 0 to 40 (preferably an integer of 2 to 27), and in the case where m3 is 0, the formula (VI) is a polypropylene glycol represented by HO—(PO)ₙ₃—H.

In the above formula (VI), the addition form (copolymerization form) of EO and PO is a random type (in random form) or a block type (in block form). The arrangement of each block in the case of the block type addition form is, for example, (a block composed of EO)-(a block composed of PO)-(a block composed of EO), (a block composed of PO)-(a block composed of EO)-(a block composed of PO), (a block composed of EO)-(a block composed of PO) or (a block composed of PO)-(a block composed of EO).

Among these, the polyether-type defoaming agent is especially preferably compounds represented by the above formula (VI) because of providing the especially good balance between the defoaming property and the low staining property. Particularly the addition form (copolymerization form) of EO and PO is a block type (in block form), and the arrangement of each block is preferably (a block composed of PO)-(a block composed of EO)-(a block composed of PO). That is, the polyether-type defoaming agent is preferably a triblock copolymer having a block composed of EO, and a block composed of PO on either side of the EO.

Examples of commercially available products of the polyether-type defoaming agent include trade names “Pronon #101P”, “Pronon #183”, “Pronon #201”, “Pronon #202B”, “Pronon #352”, “Unilube 10MS-250 KB” and “Unilube 20MT-2000B”, made by NOF Corp.; and trade names “Adeka Pluronic L-33”, “Adeka Pluronic L-42”, “Adeka Pluronic L-43”, “Adeka Pluronic L-61”, “Adeka Pluronic L-62”, “Adeka Pluronic L-71”, “Adeka Pluronic L-72”, “Adeka Pluronic L-81”, “Adeka Pluronic L-92”, “Adeka Pluronic L-101”, “Adeka Pluronic 17R-2”, “Adeka Pluronic 17R-3”, “Adeka Pluronic 25R-1” and “Adeka Pluronic 25R-2”, made by Adeka Corp.

The propylene oxide content (referred to as “PO content” in some cases) of the polyether-type defoaming agent is, in the polyether-type defoaming agent (100% by weight), 70 to 100% by weight, preferably 70 to 95% by weight, more preferably 80 to 95% by weight, still more preferably 85 to 95% by weight, and most preferably 90 to 95% by weight. If the PO content is less than 70% by weight, the staining property to an adherend is worsened. The PO content is preferably not more than 95% by weight from the viewpoint of the low staining property. Here, the above “PO content” refers to a “proportion (% by weight) of the total weight of PO (oxypropylene group) in the whole polyether-type defoaming agent (D) with respect to the total weight of the whole polyether-type defoaming agent”. A measurement method of a PO content includes, for example, NMR.

The number-average molecular weight (Mn) of the polyether-type defoaming agent is 1,200 to 4,000, and preferably 1,500 to 3,500. If Mn exceeds 4,000, the staining to an adherend occurs in some cases; and if less than 1,200, the staining to an adherend occurs in some cases. Here, the number-average molecular weight (Mn), in the case of containing two or more polyether-type defoaming agents, is a number-average molecular weight of the whole polyether-type defoaming agents. The number-average molecular weight (Mn) refers to one acquired by the measurement using GPC (gel permeation chromatography). A specific measurement method includes the following one.

### [Measurement Method]

The molecular weight is measured using a GPC apparatus “HLC-8220GPC”, made by Tosoh Corp., and determined in terms of polystyrene. The measurement condition is as follows.

Sample concentration: 0.2% by weight (THF solution)
Sample injection amount: 10 μl

### Eluent: THF

Flow rate: 0.6 ml/min
Measurement temperature: 40° C.
Column: Sample column: one column of TSKguardcolumn
SuperHZ-H+two columns of TSKgel SuperHZM-H

Reference column: one column of TSKgel SuperH-RC

Detector: differential refractometer

In the case where the acryl-based pressure-sensitive adhesive composition according to the present invention contains an acryl emulsion-based polymer, a water-insoluble crosslinking agent, an acetylenediol-based compound, and a polyether-type defoaming agent, the content of the polyether-type defoaming agent in the acryl-based pressure-sensitive adhesive composition according to the present invention is not especially limited, but is, from the viewpoint of providing a pressure-sensitive adhesive layer formed with good curl regulatability, preferably an amount of a value (B) determined by the following expression (2) of 0.2 to 2.0, wherein in the value (B), the content of the water-insoluble crosslinking agent is taken to be X parts by weight with respect to 100 parts by weight of the acryl emulsion-based polymer; and the content of the polyether-type defoaming agent is taken to be Z parts by weight with respect to 100 parts by weight of the acryl emulsion-based polymer.

Value(B)=(X)×(Z) (2)

Specifically, the content of the polyether-type defoaming agent is preferably 0.01 to 2.0 parts by weight with respect to 100 parts by weight of the acryl emulsion-based polymer. The upper limit of the content of the polyether-type defoaming agent is more preferably not more than 1.5 parts by weight, and still more preferably not more than 1.0 part by weight. The lower limit thereof is more preferably not less than 0.01 part by weight, and still more preferably not less than 0.03 part by weight. If the content of the polyether-type defoaming agent is not less than 0.03 part by weight, a rise with time of the pressure-sensitive adhesive force between a pressure-sensitive adhesive layer formed of a pressure-sensitive adhesive composition and an adherend can be prevented, and the good removability in the pressure-sensitive adhesive layer formed of the pressure-sensitive adhesive composition is easily provided, which is therefore preferable. The generation of appearance defects due to bubble faults can also be more effectively suppressed, which is preferable. On the other hand, if the content of the polyether-type defoaming agent is not more than 2.0 parts by weight, the polyether-type defoaming agent is effectively prevented from causing staining in a pressure-sensitive adhesive layer formed of a pressure-sensitive adhesive composition, which is preferable.

### (Other Additives)

The pressure-sensitive adhesive composition according to the present invention (for example, the acryl-based pressure-sensitive adhesive composition or the like according to the present invention) may contain various types of additives in the range of not impairing the advantage of the present invention. Examples of the various types of additives include pigments, fillers, dispersants, plasticizers, stabilizers, antioxidants, ultraviolet absorbents, ultraviolet stabilizers, antiaging agents and preservatives. Such additives can be used singly or in a combination of two or more.

The pressure-sensitive adhesive composition according to the present invention can be prepared by a well-known conventional method. For example, the acryl-based pressure-sensitive adhesive composition according to the present invention containing an acryl emulsion-based polymer, a water-insoluble crosslinking agent, an acetylenediol-based compound, and an ether group-containing polysiloxane or a polyether-type defoaming agent can be prepared by mixing these. Here, as required, the above additives may be blended. The mixing method usable is a well-known conventional emulsion mixing method, and is not especially limited, but preferably involves, for example, stirring using a stirrer. The stirring condition is not especially limited, but is, for example, preferably a temperature of 10 to 50° C., and more preferably a temperature of 20 to 35° C. The stirring time is preferably 5 to 30 min, and more preferably 10 to 20 min. The stirring rotation frequency is preferably 10 to 2,500 rpm, and more preferably 30 to 2,000 rpm.

The pressure-sensitive adhesive composition according to the present invention can form a pressure-sensitive adhesive layer capable of exhibiting good curl regulatability. The pressure-sensitive adhesive composition according to the present invention can further form a pressure-sensitive adhesive layer having the good removability, being excellent in the environmental aspect, and having the low staining property.

### [Pressure-Sensitive Adhesive Sheet]

The pressure-sensitive adhesive sheet according to the present invention is a pressure-sensitive adhesive sheet having at least a pressure-sensitive adhesive layer formed of the above pressure-sensitive adhesive composition according to the present invention (for example, the above acryl-based pressure-sensitive adhesive composition according to the present invention). The pressure-sensitive adhesive sheet according to the present invention may be a pressure-sensitive adhesive sheet with a base material, in which at least one surface side of the base material has the pressure-sensitive adhesive layer, or may be a base material-less pressure-sensitive adhesive layer constituted of the pressure-sensitive adhesive layer alone. Since the pressure-sensitive adhesive sheet according to the present invention is preferably used particularly for the surface protection as described later, the pressure-sensitive adhesive sheet is preferably a pressure-sensitive adhesive sheet with a base material, and more preferably a single-sided pressure-sensitive adhesive sheet with a base material, in which one surface side of the base material has the pressure-sensitive adhesive layer.

The pressure-sensitive adhesive sheet according to the present invention may be a single-sided pressure-sensitive adhesive sheet or a double-sided pressure-sensitive adhesive sheet. The pressure-sensitive adhesive sheet according to the present invention may further be of a laminated form in which pressure-sensitive adhesive sheets are laminated, or may be of a form in which a pressure-sensitive adhesive sheet is wound in a roll shape.

The pressure-sensitive adhesive sheet according to the present invention is produced by forming a pressure-sensitive adhesive layer by a well-known conventional method by using the above pressure-sensitive adhesive composition according to the present invention (for example, the acryl-based pressure-sensitive adhesive composition). The single-sided pressure-sensitive adhesive sheet with a base material is produced, for example, by forming a pressure-sensitive adhesive layer by coating the above pressure-sensitive adhesive composition according to the present invention on at least one surface side of the base material to provide a coated layer, which is heated and dried (direct transfer method). The single-sided pressure-sensitive adhesive sheet with a base material is produced also by once providing a pressure-sensitive adhesive layer on a release liner, and thereafter transferring the pressure-sensitive adhesive layer on at least one surface side of a base material (transfer method). As required, warming and the like may further be carried out after the heating and drying step. For example, in order to more raise the degree of crosslinking, warming of the pressure-sensitive adhesive sheet may be carried out after dehydration and drying in the drying step. Particularly the single-sided pressure-sensitive adhesive sheet with a base material is preferably produced by the so-called direct transfer method. This is because the transfer method cannot provide a sufficient anchoring property (close adhesion) with the base material in some cases.

The thickness of the pressure-sensitive adhesive layer of the pressure-sensitive adhesive sheet according to the present invention is not especially limited, but is preferably 1 to 50 μm, more preferably 1 to 35 μm, and still more preferably 3 to 25 μm.

The solvent-insoluble content (gel fraction) of a pressure-sensitive adhesive layer of the pressure-sensitive adhesive sheet according to the present invention (particularly a pressure-sensitive adhesive layer formed of the above acryl-based pressure-sensitive adhesive composition according to the present invention) is not especially limited, but is preferably not less than 90% (% by weight), and more preferably not less than 95% by weight. If the solvent-insoluble content is not less than 90% by weight, the content can suppress the occurrence of the following problems: a pressure-sensitive adhesive layer cannot be provided with a sufficient cohesive force, and the curl regulatability is adversely affected; and the blushing staining generated by an increase in transfer of staining substances to an adherend, and the insufficiency of the removability (hardly peelable state) can be more suppressed, which are preferable. Here, the solvent-insoluble content of the pressure-sensitive adhesive layer can be measured by the similar method as the above-mentioned measurement method of the solvent-insoluble content of an acryl emulsion-based polymer. Specifically, the measurement can be carried out by a method in which “acryl emulsion-based polymer” in the above-mentioned “measurement method of the solvent-insoluble content” is replaced by “pressure-sensitive adhesive layer” in reading.

A base material in the case where the pressure-sensitive adhesive sheet according to the present invention is a pressure-sensitive adhesive sheet with the base material is not especially limited, but is preferably a plastic base material (for example, a plastic film or a plastic sheet) from the viewpoint of providing a pressure-sensitive adhesive sheet having a high transparency. The material of the plastic base material is not especially limited, but is, for example, preferably a transparent resin including polyolefin (polyolefin-based resins) such as polypropylene and polyethylene, polyester (polyester-based resins) such as polyethylene terephthalate (PET), polycarbonate, polyamide, polyimide, acrylic resins, polystyrene, acetate resins, polyether sulfone and triacetyl cellulose. These resins may be used singly or in a combination of two or more. Among these, polyester-based resins and polyolefin-based resins are preferable, and from the viewpoint of the productivity and the moldability, polyethylene terephthalate, polypropylene and polyethylene are more preferable. The polypropylene is not especially limited, but includes a homo-type one being a homopolymer, a random-type one being an α-olefin random copolymer, and a block-type one being an α-olefin block copolymer. The polyethylene includes a low-density polyethylene (LDPE), a high-density polyethylene (HDPE) and a linear low-density polyethylene (L-LDPE). These may be used singly or in a combination of two or more. Here, the thickness of the base material is not especially limited, but is preferably 10 to 150 μm, and more preferably 30 to 100 μm.

It is preferable that the surface of the base material on the side provided with a pressure-sensitive adhesive layer, for the purpose including improving the close adhesion force with a pressure-sensitive adhesive layer, has been subjected to easy-adhesion treatments such as an acid treatment, an alkali treatment, a primer treatment, a corona treatment, a plasma treatment and an ultraviolet treatment. A middle layer may further be provided between a base material and a pressure-sensitive adhesive layer. The thickness of the middle layer is, for example, preferably 0.01 to 1 μm, and more preferably 0.1 to 1 μm.

The pressure-sensitive adhesive layer surface (pressure-sensitive adhesive surface) of the pressure-sensitive adhesive sheet according to the present invention may be protected by a release liner (separator). The pressure-sensitive adhesive sheet according to the present invention can be made to be a wound body as described above, and can be taken up in a roll shape in the state that the pressure-sensitive adhesive layer is protected by the release liner. Further in the case where the pressure-sensitive adhesive sheet according to the present invention is a single-sided pressure-sensitive adhesive sheet with a base material, the back surface (the surface on the opposite side to the side provided with a pressure-sensitive adhesive layer) of the base material of the pressure-sensitive adhesive sheet may be subjected to a release treatment and/or a stainproofing treatment, with a silicone-, a fluorine-, a long chain alkyl- or a fatty acid amide-based release agent, a silica powder or the like, to thereby provide a back surface-treated layer (release treatment layer, stainproofing treatment layer or the like). The pressure-sensitive adhesive sheet may further be made to be a wound body and have a form of protecting the pressure-sensitive adhesive surface by the back surface of the base material. The pressure-sensitive adhesive sheet according to the present invention may have a laminated form of a pressure-sensitive adhesive layer/a base material/a back surface-treated layer.

The pressure-sensitive adhesive force (under the environment of 23° C. and 50% RH, at a tensile rate of 0.3 m/min, 1800 peeling) of the pressure-sensitive adhesive sheet according to the present invention is not especially limited, but is, from the viewpoint of providing the good removability, preferably not more than 0.05 N/25 mm, and more preferably not more than 0.04 N/25 mm. The lower limit of the pressure-sensitive adhesive force is not especially limited, but is, from the viewpoint of suppressing the lifting and the peeling of the pressure-sensitive adhesive sheet from an adherend, preferably not less than 0.010 N/25 mm, and more preferably not less than 0.015 N/25 mm.

Particularly the pressure-sensitive adhesive force of the pressure-sensitive adhesive sheet according to the present invention is, from the viewpoint of giving the good removability to optical components (optical components described later, for example, polarizing plates) regardless of surface polarity, that is, even if the surface is of low polarity or high polarity, preferably not more than 0.035 N/25 mm, and more preferably not more than 0.030 N/25 mm. The lower limit of the pressure-sensitive adhesive force is not especially limited, but is preferably not less than 0.010 N/25 mm, and more preferably not less than 0.015 N/25 mm. If the pressure-sensitive adhesive force is not more than 0.035 N/25 mm, in a manufacture process of optical components and products using optical components (for example, polarizing plates and liquid crystal displays), the following problem is unlikely to arise: the pressure-sensitive adhesive sheet is unlikely to become peeled, and the productivity and the handleability are decreased, which is therefore preferable. If not less than 0.010 N/25 mm, in a manufacture process of optical components and products using optical components (for example, polarizing plates and liquid crystal displays), the trouble of generating the lifting and the peeling of the pressure-sensitive adhesive sheet becomes easily suppressed, which is therefore preferable.

In the pressure-sensitive adhesive sheet according to the present invention, from the viewpoint of providing a good property of preventing a rise in the pressure-sensitive adhesive force and providing the good removability, both the “initial pressure-sensitive adhesive force” (pressure-sensitive adhesive force of the pressure-sensitive adhesive sheet immediately after the manufacture) and the “pressure-sensitive adhesive force after storage at 40° C. for 3 days” (pressure-sensitive adhesive force of the pressure-sensitive adhesive sheet stored in an environment of 40° C. for 3 days after the manufacture) are preferably not more than 0.035 N/25 mm, and more preferably not more than 0.030 N/25 mm.

The pressure-sensitive adhesive sheet according to the present invention, since having a pressure-sensitive adhesive layer formed of the above pressure-sensitive adhesive composition according to the present invention, can exhibit good curl regulatability. The pressure-sensitive adhesive sheet also has the good removability, excels in the environmental aspect, and excels in the low staining property without causing staining such as blushing staining even if being laminated on an adherend.

The pressure-sensitive adhesive sheet according to the present invention is preferably used for applications in which the pressure-sensitive adhesive sheet is removed [for example, masking tapes such as masking tapes for curing in construction, the masking tapes for automobile painting, masking tapes for electronic components (lead frames, printed circuit boards and the like) and masking tapes for sandblasting, surface protection films such as surface protection films for aluminum sashes, surface protection films for optical plastics, surface protection films for optical glasses, surface protection films for automobile protection and surface protection films for metal plates, pressure-sensitive adhesive tapes for process of manufacturing semiconductors and electronic components such as backgrind tapes, pellicle-fixing tapes, dicing tapes, lead frame-fixing tapes, cleaning tapes, dust removing tapes, carrier tapes and cover tapes, tapes for packaging electronic devices and electronic components, temporary fixing tapes in transportation, binding tapes, and labels].

Particularly the pressure-sensitive adhesive sheet according to the present invention excels in the curl regulatability, and can suppress the generation of curl when being laminated on an adherend. The pressure-sensitive adhesive sheet can further exhibit the good removability, and excels in the low staining property. Therefore, the pressure-sensitive adhesive sheet according to the present invention is preferably used as surface protection applications (surface protection films and the like for optical components) of optical components (optical plastics, optical glasses, optical films and the like) including polarizing plates, retardation plates, antireflection plates, wave plates, optical compensation films and luminance enhancing films constituting panels of liquid crystal displays, organic electroluminescences (organic EL), field emission displays and the like. However, the applications are not limited thereto, and the pressure-sensitive adhesive sheet can also be used for the surface protection, the damage prevention, the removal of foreign matter and the like, masking and the like in manufacture of microfabricated components such as semiconductors, circuits, various types of printed boards, various types of masks, and lead frames.

For example, if the pressure-sensitive adhesive sheet according to the present invention is used for a surface protection application of a polarizing plate constituting the panel, the generation of failures in the process in the panel production case can be reduced, which is preferable. This is because if a polarizing plate is laminated on a given position to produce the panel in the state that minus curl (also referred to as “inverse curl”, such a curl that the laminated side becomes concave) or wave curl (wholly wavy curl) is generated on the polarizing plate, bubbles become liable to be involved, that is, bubbles become liable to be enclosed between the pressure-sensitive adhesive surface and the adherend, to thereby make failures in the process in the panel production case to be liable to be generated; however, the pressure-sensitive adhesive sheet according to the present invention excels in the curl regulatability, and can generate plus curl (also referred to as “normal curl”, such a curl that the laminated side becomes convex) which can reduce the generation of such failures in the process on the polarizing plate and can maintain this.

### [Optical Component]

The optical component according to the present invention has a structure in which the above pressure-sensitive adhesive sheet is laminated. That is, the optical component according to the present invention has a laminated structure of an optical component and the pressure-sensitive adhesive sheet according to the present invention.

The optical component according to the present invention, since the above pressure-sensitive adhesive sheet is laminated on the surface of an optical component, has a structure in which the surface is protected by the pressure-sensitive adhesive sheet. Therefore, flaws and cracks are hardly generated on the surface. Since the pressure-sensitive adhesive sheet can play a role of a pasteboard and a support base, the pressure-sensitive adhesive sheet exhibits excellent workability in processes such as cutting process.

The optical component according to the present invention, since having a laminated structure with the pressure-sensitive adhesive sheet according to the present invention excellent in the curl regulatability, is suppressed in the generation of curl. Therefore, in the process of fabricating products using the optical component (for example, the above panel), failures in the process are hardly generated. The optical component according to the present invention thus contributes to improvement in the yield of the products using the optical component. Further since the laminated pressure-sensitive adhesive sheet in the optical component according to the present invention is excellent in the removability, the optical component according to the present invention exhibits the good workability. This fact also contributes to improvement in the yield of the products using the optical component.

### EXAMPLES

Hereinafter, the present invention will be described in more detail by way of Examples, but the present invention is not any more limited to these Examples.

### Examples and Comparative Examples

### Preparation of an Acryl Emulsion Polymer

90 parts by weight of water, and raw material monomers and a reactive surfactant (made by Daiichi Kogyo Seiyaku Co., Ltd., trade name: “Aquaron HS-1025, a reactive emulsifying agent containing a radical polymerizable functional group in the molecule) in blend amounts shown in Table 1 were blended in a vessel, thereafter stirred and mixed by a homomixer to thereby prepare a monomer emulsion.

Then, 50 parts by weight of water, 0.01 part by weight of a polymerization initiator (ammonium persulfate), and an amount of 10% by weight out of the monomer emulsion prepared in the above were added to a reaction vessel equipped with a cooling tube, a nitrogen introducing tube, a thermometer and a stirrer to be subjected to emulsion-polymerization at 75° C. for 1 hour under stirring. Thereafter, 0.07 part by weight of the polymerization initiator (ammonium persulfate) was further added; and all of the remaining monomer emulsion (an amount of 90% by weight thereof) was then added over 3 hours under stirring; and thereafter, the resultant was allowed to react at 75° C. for 3 hours. Then, the resultant was cooled to 30° C.; ammonia water of 10% by weight in concentration was added to regulate the pH at 8 to thereby prepare a water dispersion liquid of an acryl emulsion-based polymer (concentration of the acryl emulsion-based polymer: 41% by weight).

### (Preparation of Removable Water-Dispersible Acryl-Based Pressure-Sensitive Adhesive Compositions)

With respect to 244 parts by weight of the water dispersion liquid (41% by weight) of the acryl emulsion-based polymer obtained in the above (100 parts by weight of the acryl emulsion-based polymer), an epoxy-based crosslinking agent (made by Mitsubishi Gas Chemical Co., Ltd., trade name: “Tetrad-C”, 1,3-bis(N,N-diglycidylaminomethyl)cyclohexane, epoxy equivalent: 110, the number of functional groups: 4) being a water-insoluble crosslinking agent of an amount shown in Table 1, an acetylenediol-based compound (composition) of 4 in HLB value (made by Air Products and Chemicals, Inc., trade name: “Surfynol 420”, effective component: 100% by weight) of an amount shown in Table 1, an ether group-containing polysiloxane (made by Shin-Etsu Chemical Co., Ltd., trade name: “Modified Silicone Oil KF-353”) of an amount shown in Table 1, and a polyether-type defoaming agent (made by Adeka Corp., trade name: “Adeka Pluronic 25R-1”) of an amount shown in Table 1 were stirred and mixed using a stirrer under the stirring condition of 23° C., 2,000 rpm and for 10 min to thereby prepare respective removable water-dispersible acryl-based pressure-sensitive adhesive compositions.

In Table 1, “-” indicates no use.

### (Formation of Pressure-Sensitive Adhesive Layers, Production of Pressure-Sensitive Adhesive Sheets)

The removable water-dispersible acryl-based pressure-sensitive adhesive compositions obtained in the above were each applied on the corona-treated surface of a PET film (made by Toyobo Co., Ltd., trade name: “E7415”, thickness: 38 μm) by using an applicator, made by Tester Sangyo Co., Ltd., so that the thickness after drying became 20 μm, thereafter dried in a hot air circulating oven at 120° C. for 2 min, and thereafter further cured (aged) at 23° C. for 5 days to thereby obtain a pressure-sensitive adhesive sheet.

### Evaluations

The pressure-sensitive adhesive sheets obtained in Examples and Comparative Examples were evaluated by the following measurement methods or evaluation methods. The results are shown in Table 1.

### Pressure-Sensitive Adhesive Force

### (Initial Pressure-Sensitive Adhesive Force)

From the pressure-sensitive adhesive sheets each, a measuring sample of a sheet shape of 25 mm in width and 100 mm in length was obtained. Then, the measuring sample was laminated on a platy adherend by using a laminator (made by Tester Sangyo Co., Ltd., a small-size laminator) under conditions of 0.26 MPa and 0.3 m/min. Then, the laminated pressure-sensitive adhesive sheet was left in the environment of 23° C. and 50% RH for 30 min.

After being left, the laminated pressure-sensitive adhesive sheet was subjected to a 180° peeling test using a tensile test machine under the environment of 23° C. and 50% RH at a tensile rate of 0.3 m/min to thereby measure a pressure-sensitive adhesive force (peeling force) (N/25 mm). Then, the pressure-sensitive adhesive force was taken as an “initial pressure-sensitive adhesive force”.

The adherend used was a polarizing plate (trade name: “SEG14251DU”, made by Nitto Denko Corp., the surface is of a high polarity, triacetyl cellulose polarizing plate) (simply referred to as “high-polarity-surface polarizing plate” in some cases), and a triacetyl cellulose polarizing plate of the surface of a low polarity (the surface was subjected to an antiglare coating treatment) (simply referred to as “low-polarity-surface polarizing plate” in some cases).

With respect to the initial pressure-sensitive adhesive forces acquired, the pressure-sensitive adhesive forces for the high-polarity-surface polarizing plate are shown in the column of “Initial Pressure-Sensitive Adhesive Force High-Polarity-Surface Polarizing Plate” in Table 1, and the pressure-sensitive adhesive forces for the low-polarity-surface polarizing plate are shown in the column of “Initial Pressure-Sensitive Adhesive Force Low-Polarity-Surface Polarizing Plate” in Table 1.

(Pressure-Sensitive Adhesive Force after Storage at 40° C. For 3 Days)

From the pressure-sensitive adhesive sheets each, a measuring sample of a sheet shape of 25 mm in width and 100 mm in length was obtained. Then, the measuring sample was laminated on a platy adherend by using a laminator (made by Tester Sangyo Co., Ltd., a small-size laminator) under conditions of 0.26 MPa and 0.3 m/min. Then, the laminated pressure-sensitive adhesive sheet was stored in the environment of 40° C. for 3 days, and thereafter left under the environment of 23° C. and 50% RH for 2 hours.

After being left, the laminated pressure-sensitive adhesive sheet was subjected to a 180° peeling test using a tensile test machine under the environment of 23° C. and 50% RH at a tensile rate of 0.3 m/min to thereby measure a pressure-sensitive adhesive force (peeling force) (N/25 mm). Then, the pressure-sensitive adhesive force was taken as a “pressure-sensitive adhesive force after storage at 40° C. for 3 days”.

The adherend used was the high-polarity-surface polarizing plate and the low-polarity-surface polarizing plate.

With respect to the acquired pressure-sensitive adhesive forces after storage at 40° C. for 3 days, the pressure-sensitive adhesive forces for the high-polarity-surface polarizing plate are shown in the column of “Pressure-Sensitive Adhesive Force After Storage at 40° C. for 3 Days High-Polarity-Surface Polarizing Plate” in Table 1, and the pressure-sensitive adhesive forces for the low-polarity-surface polarizing plate are shown in the column of “Pressure-Sensitive Adhesive Force After Storage at 40° C. for 3 Days Low-Polarity-Surface Polarizing Plate” in Table 1.

### Curl Test

On the high-polarity-surface polarizing plate (140 mm in width, 200 mm in length, 0.2 mm in thickness) left still on a metal plate, the pressure-sensitive adhesive sheet cut into a slightly larger size than the high-polarity-surface polarizing plate was laminated by using a laminator (made by Tester Sangyo Co., Ltd., a small-size laminator) under conditions of 0.26 MPa and 0.3 m/min so that the length direction of the high-polarity-surface polarizing plate and the length direction of the pressure-sensitive adhesive sheet were coincident. In the laminating, the laminating was carried out while the pressure-sensitive adhesive sheet was being drawn. After the laminating, the pressure-sensitive adhesive sheet protruding from the high-polarity-surface polarizing plate was cut. Thus, an evaluation sample was obtained which has a structure in which the surface of the high-polarity-surface polarizing plate was protected by the pressure-sensitive adhesive sheet.

Then, the evaluation sample was placed on a flat surface, and respective distances (distances in the height direction) from the flat surface to four corners of the sample were measured. Then, an average of these values was determined, and the average was taken as an “initial curl height”.

After the determination of the “initial curl height”, the evaluation sample was left under the environment of 23° C. and 50% RH for 20 hours. After being left, the evaluation sample was placed on a flat surface, and respective distances (distances in the height direction) from the flat surface to four corners of the sample were measured. Then, an average of these values was determined, and the average was taken as a “curl height after 20 hours”.

Then, a difference between the “initial curl height” and the “curl height after 20 hours” ([(initial curl height)-(curl height after 20 hours)], referred to as a “difference in curl height” in some cases) was determined.

With respect to the evaluated curl regulatability, the “initial curl heights” are shown in the column of “Curl Regulatability Initial Curl. Height” in Table 1; the “curl heights after 20 hours” are shown in the column of “Curl Regulatability Curl Height after 20 Hours” in Table 1; and the “differences in curl height” are shown in the column of “Curl. Regulatability Difference in Curl Height” in Table 1.

### Curl Regulatability

The case satisfying both the following requirement 1 and requirement 2 was evaluated as “good” (O); and by contrast, the case satisfying neither of, and the case satisfying only one of the following requirement 1 and requirement 2 were evaluated as “poor” (x).

Requirement 1: The “initial curl height” determined in the above curl test was not less than 20 mm.
Requirement 2: The “difference in curl height” determined in the above curl test was not more than 10 mm.

With the curl regulatability being good, the curl is regulated in an optical component having a pressure-sensitive adhesive sheet laminated thereon, and the generation of failures in the process of fabricating a product using the optical component can be prevented. By contrast, with the curl regulatability being poor, the curl is not sufficiently regulated in an optical component having a pressure-sensitive adhesive sheet laminated thereon, and failures in the process of fabricating a product using the optical component are generated in some cases.

TABLE 1

| | | | | | | | | | Comparative |
|---|---|---|---|---|---|---|---|---|---|
| | | | Example | | | | | | Example |
| | | | 1 | 2 | 3 | 4 | 5 | 6 | 1 |
| Acryl | Raw Material Monomer | 2EHA | 92 | 92 | 92 | 92 | 92 | 92 | 92 |
| Emulsion- | (parts by weight) | AA | 4 | 4 | 4 | 4 | 4 | 4 | 4 |
| based | | MMA | 4 | 4 | 4 | 4 | 4 | 4 | 4 |
| Polymer | Emulsifying Agent | HS-1025 | 3 | 3 | 3 | 3 | 3 | 3 | 3 |
| | (parts by weight) | | | | | | | | |
| Removable | Acryl Emulsion-based Polymer | | 100 | 100 | 100 | 100 | 100 | 100 | 100 |
| Water- | (parts by weight) | | | | | | | | |
| Dispersible | Acetylenediol-based | Surfynol 420 | 1 | 1 | 1 | 1 | 1 | 1 | 1 |
| Acryl-based | Compound (parts by weight) | | | | | | | | |
| Pressure- | Water-Insoluble Crosslinking | TETRAD-C | 2.00 | 2.15 | 2.50 | 1.80 | 2.50 | 2.85 | 3.00 |
| Sensitive | Agent (parts by weight) | | | | | | | | |
| Adhesive | Ether Group-Containing | KF-353 | 0.30 | 0.16 | 0.10 | 0.32 | — | 0.16 | 0.30 |
| Composition | Polysiloxane (parts by weight) | | | | | | | | |
| | Polyether-type Defoaming | 25R-1 | — | — | — | — | 0.30 | — | — |
| | Agent (parts by weight) | | | | | | | | |

| (The Number in parts by weight of the Water-Insoluble Crosslinking | | 0.60 | 0.34 | 0.25 | 0.58 | 0.75 | 0.45 | 0.90 |
|---|---|---|---|---|---|---|---|---|
| Agent) × (the Number in parts by weight of the Ether Group- | | | | | | | | |
| Containing Polysiloxane) or (The Number in parts by weight of the | | | | | | | | |
| Water-Insoluble Crosslinking Agent) × (the Number in parts by weight | | | | | | | | |
| of the Polyether-type Defoaming Agent) | | | | | | | | |
| Curl Test | Initial Curl Height | 36.3 | 42.0 | 36.8 | 40.0 | 53.3 | 50.8 | 34.3 |
| | (mm) | | | | | | | |
| | Curl Height After | 33.0 | 36.5 | 29.5 | 33.7 | 49.5 | 41.8 | 0.0 |
| | 20 Hours (mm) | | | | | | | |
| | Difference in Curl | 3.3 | 5.5 | 7.3 | 6.3 | 3.8 | 9.0 | 34.3 |
| | Height (mm) | | | | | | | |
| Curl Regulatability | | ∘ | ∘ | ∘ | ∘ | ∘ | ∘ | x |
| Initial Pressure-Sensitive Adhesive | High-Polarity-Surface | 0.036 | 0.046 | 0.047 | 0.051 | 0.095 | 0.022 | 0.023 |
| Force (N/25 mm) | Polarizing Plate | | | | | | | |
| (tensile rate: 0.3 m/min, 180° peeling) | Low-Polarity-Surface | 0.046 | 0.055 | 0.061 | 0.041 | 0.046 | 0.029 | 0.013 |
| | Polarizing Plate | | | | | | | |
| Pressure-Sensitive Adhesive Force After | High-Polarity-Surface | 0.043 | 0.047 | 0.042 | 0.090 | 0.085 | 0.030 | 0.020 |
| Storage at 40° C. for 3 Days (N/25 mm) | Polarizing Plate | | | | | | | |
| (tensile rate: 0.3 m/min, 180° peeling) | Low-Polarity-Surface | 0.042 | 0.042 | 0.041 | 0.062 | 0.083 | 0.025 | 0.013 |
| | Polarizing Plate | | | | | | | |

| | | | Comparative Example | | | | | |
|---|---|---|---|---|---|---|---|---|
| | | | 2 | 3 | 4 | 5 | 6 | 7 |
| Acryl | Raw Material Monomer | 2EHA | 92 | 92 | 92 | 92 | 92 | 92 |
| Emulsion- | (parts by weight) | AA | 4 | 4 | 4 | 4 | 4 | 4 |
| based | | MMA | 4 | 4 | 4 | 4 | 4 | 4 |
| Polymer | Emulsifying Agent | HS-1025 | 3 | 3 | 3 | 3 | 3 | 3 |
| | (parts by weight) | | | | | | | |
| Removable | Acryl Emulsion-based Polymer | | 100 | 100 | 100 | 100 | 100 | 100 |
| Water- | (parts by weight) | | | | | | | |
| Dispersible | Acetylenediol-based | Surfynol 420 | 1 | 1 | 1 | 1 | 1 | 1 |
| Acryl-based | Compound (parts by weight) | | | | | | | |
| Pressure- | Water-Insoluble Crosslinking | TETRAD-C | 2.85 | 2.50 | 2.15 | 2.50 | 2.50 | 3.50 |
| Sensitive | Agent (parts by weight) | | | | | | | |
| Adhesive | Ether Group-Containing | KF-353 | 0.44 | 0.50 | 0.44 | 0.30 | 0.30 | — |
| Composition | Polysiloxane (parts by weight) | | | | | | | |
| | Polyether-type Defoaming | 25R-1 | — | — | — | — | — | 1.00 |
| | Agent (parts by weight) | | | | | | | |

| (The Number in parts by weight of the Water-Insoluble Crosslinking | | 1.26 | 1.25 | 0.95 | 0.75 | 0.75 | 3.50 |
|---|---|---|---|---|---|---|---|
| Agent) × (the Number in parts by weight of the Ether Group- | | | | | | | |
| Containing Polysiloxane) or (The Number in parts by weight of the | | | | | | | |
| Water-Insoluble Crosslinking Agent) × (the Number in parts by weight | | | | | | | |
| of the Polyether-type Defoaming Agent) | | | | | | | |
| Curl Test | Initial Curl Height | 26.5 | 14.8 | 36.3 | 47.8 | 45.0 | 55.8 |
| | (mm) | | | | | | |
| | Curl Height After | 0.0 | 0.0 | 25.0 | 13.8 | 16.0 | 0.5 |
| | 20 Hours (mm) | | | | | | |
| | Difference in Curl | 26.5 | 14.8 | 11.3 | 34.0 | 29.0 | 55.3 |
| | Height (mm) | | | | | | |
| Curl Regulatability | | x | x | x | x | x | x |
| Initial Pressure-Sensitive Adhesive | High-Polarity-Surface | 0.014 | 0.014 | 0.024 | 0.026 | 0.029 | 0.030 |
| Force (N/25 mm) | Polarizing Plate | | | | | | |
| (tensile rate: 0.3 m/min, 180° peeling) | Low-Polarity-Surface | 0.016 | 0.023 | 0.034 | 0.031 | 0.032 | 0.029 |
| | Polarizing Plate | | | | | | |
| Pressure-Sensitive Adhesive Force After | High-Polarity-Surface | 0.017 | 0.022 | 0.034 | 0.032 | 0.030 | 0.041 |
| Storage at 40° C. for 3 Days (N/25 mm) | Polarizing Plate | | | | | | |
| (tensile rate: 0.3 m/min, 180° peeling) | Low-Polarity-Surface | 0.013 | 0.014 | 0.035 | 0.024 | 0.024 | 0.181 |
| | Polarizing Plate | | | | | | |

The abbreviations used in Table 1 are as follows. In Table 1, the blend amount of each component of the acryl-based pressure-sensitive adhesive compositions are indicated in an actual blend amount (a blend amount of a substance). The amount of the acryl emulsion-based polymer was indicated in terms of solid content weight.

### (Raw Material Monomers)

2EHA: 2-ethylhexyl acrylate

MMA: methyl methacrylate

AA: acrylic acid

### (Emulsifying Agent)

HS-1025: made by Daiichi Kogyo Seiyaku Co., Ltd., trade name: “Aquaron HS-1025” (a reactive surfactant, a reactive emulsifying agent containing a radical polymerizable functional group in the molecule)

### (Acetylenediol-Based Compound)

Surfynol 420: made by Air Products and Chemicals, Inc., trade name: “Surfynol 420” (HLB value: 4, effective component: 100% by weight)

### (Water-Insoluble Crosslinking Agent)

TETRAD-C: made by Mitsubishi Gas Chemical Co., Ltd., trade name: “TETRAD-C” (1,3-bis(N,N-diglycidylaminomethyl)cyclohexane, epoxy equivalent: 110, the number of functional groups: 4)

### (Ether Group-Containing Polysiloxane)

KF-353: made by Shin-Etsu Chemical Co., Ltd., trade name: “Modified Silicone Oil KF-353”

### (Polyether-Type Defoaming Agent)

25R-1: made by Adeka Corp., trade name: “Adeka Pluronic 25R-1”

### REFERENCE SIGNS LIST

1 SAMPLE FOR CURL TEST EVALUATION
11 POLARIZING PLATE
12 PRESSURE-SENSITIVE ADHESIVE SHEET FOR TEST
A FLAT SURFACE
h1, h2 CURL HEIGHT

1. A removable water-dispersible pressure-sensitive adhesive composition, forming a pressure-sensitive adhesive layer of a pressure-sensitive adhesive sheet, wherein the pressure-sensitive adhesive sheet has an initial curl height of not less than 20 mm as determined by the following curl test, and a difference in curl height of not more than 10 mm as determined by the following curl test,
the curl test being such that:
the pressure-sensitive adhesive layer of 20 μm in thickness of the removable water-dispersible pressure-sensitive adhesive composition is formed on one surface of a polyethylene terephthalate base material of 38 μm in thickness to thereby obtain a pressure-sensitive adhesive sheet for the test having the pressure-sensitive adhesive layer on the one surface of the polyethylene terephthalate base material;
the pressure-sensitive adhesive sheet for the test is laminated on a triacetyl cellulose-made polarizing plate (trade name: “SEG1425DU”, made by Nitto Denko Corp., 140 mm in width, 200 mm in length, 0.2 mm in thickness) by using a laminator under conditions of 0.26 MPa and 0.3 m/min so that the length direction of the polarizing plate and the length direction of the pressure-sensitive adhesive sheet for the test are coincident, to thereby obtain a sample for curl test evaluation;
the sample for curl test evaluation is placed on a flat surface, and respective distances (distances in the height direction) from the flat surface to four corners of the sample are measured, and an average of these values is then determined, and is taken as an “initial curl height”;
after the determination of the “initial curl height”, the sample for evaluation is left under an environment of 23° C. and 50% RH for 20 hours, and after being left, the sample for evaluation is placed on a flat surface, and respective distances (distances in the height direction) from the flat surface to four corners of the sample are measured, and an average of these values is then determined, and is taken as a “curl height after 20 hours”; and
a “difference in curl height” is then determined from the difference between the “initial curl height” and the “curl height after 20 hours”.

2. A removable water-dispersible pressure-sensitive adhesive composition, comprising an acryl emulsion-based polymer, a water-insoluble crosslinking agent, an acetylenediol-based compound, and an ether group-containing polysiloxane or a polyether-type defoaming agent,
wherein the acryl emulsion-based polymer comprises an alkyl(meth)acrylate and a carboxyl group-containing unsaturated monomer as essential raw material monomers, wherein a content of the alkyl(meth)acrylate is 70 to 99.5% by weight with respect to a total amount of the raw material monomers, and a content of the carboxyl group-containing unsaturated monomer is 0.5 to 10.0% by weight with respect to the total amount of the raw material monomers; and
wherein a value (A) determined by the following expression (1) is 0.2 to 0.7, or a value (B) determined by the following expression (2) is 0.2 to 2.0:
Value(A)=(X)×(Y) (1); and
Value(B)=(X)×(Z) (2),
wherein X is a content of the water-insoluble crosslinking agent, which is expressed in an amount thereof (parts by weight) with respect to 100 parts by weight of the acryl emulsion-based polymer;
Y is a content of the ether group-containing polysiloxane, which is expressed in an amount thereof (parts by weight) with respect to 100 parts by weight of the acryl emulsion-based polymer; and
Z is a content of the polyether-type defoaming agent, which is expressed in an amount thereof (parts by weight) with respect to 100 parts by weight of the acryl emulsion-based polymer.

3. A pressure-sensitive adhesive sheet, having a pressure-sensitive adhesive layer formed of a removable water-dispersible pressure-sensitive adhesive composition according to claim 1.

4. An optical component, having a pressure-sensitive adhesive sheet according to claim 3 laminated thereon.

5. A pressure-sensitive adhesive sheet, having a pressure-sensitive adhesive layer formed of a removable water-dispersible pressure-sensitive adhesive composition according to claim 2.

6. An optical component, having a pressure-sensitive adhesive sheet according to claim 5 laminated thereon.
